(19) United States
(12) Patent Application Publication
(10) Pub. No.: US 2026/0055477 A1
(43) Pub. Date: Feb. 26, 2026

(54) A DIRECT REDUCTION FACILITY AND A METHOD OF DIRECT REDUCTION OF METAL OXIDE

(71) Applicant: LUOSSAVAARA-KIIRUNAVAARA AB, LULEÅ (SE)

(72) Inventors: Ola Eriksson, Kiruna (SE); Björn Åström, Kiruna (SE); Daniel Marjavaara, Kiruna (SE); Susanne ROSTMARK, Kiruna (SE); Göran TUOMAS, Luleå (SE)

(21) Appl. No.: 19/100,810

(22) PCT Filed: Aug. 18, 2023
(86) PCT No.: PCT/SE2023/050839

§ 371 Date: Feb. 3, 2025

(30) Foreign Application Priority Data
Aug. 18, 2022 (SE) 2250976-4

(51) Int. Cl. C21B 13/00; C21B 13/12

(52) U.S. Cl. CPC C21B 13/006; C21B 13/004; C21B 13/0086; C21B 13/12

(57) ABSTRACT

The present invention relates to a metal material production configuration (1) and to a method of direct reduction of a metal oxide material (5) holding a first thermal energy into a reduced metal material (16). The method comprises the steps of charging the metal oxide material (5) holding the first thermal energy into a direct reduction facility (7) via a metal oxide material charging inlet device (A), introducing a pre-heated hydrogen containing reducing agent (H), holding a second thermal energy, into the direct reduction facility (7) via a reducing agent inlet device (B).

The metal oxide material (5) id direct reduced by using the first thermal energy of the metal oxide material (5) to heat or further heat the introduced pre-heated hydrogen containing reducing agent (H) for providing a chemical reaction between the introduced pre-heated hydrogen containing reducing agent (H) and the metal oxide material (5); exposing the reduced metal material to a required heat treatment temperature for providing heat treatment of the reduced metal material to obtain a densified reduced metal material; and upholding the required heat treatment temperature by the introduction of the pre-heated hydrogen containing reducing agent (H) by means of a heat treatment providing device (17).

### TECHNICAL FIELD

The present invention relates to a method of direct reduction of a metal oxide material into a reduced metal material.

The present invention further relates to a direct reduction facility configured to reduce the metal oxide material and producing a reduced metal material (e.g. sponge iron).

The present invention further relates to a metal material production configuration configured for production of a reduced metal material that is resistant to re-oxidation for cost-effective and secure fire resistant transport of the reduced metal material to a metal making industry or other customers.

The present invention further relates to a data program adapted to control selected parts of the direct reduction facility and/or metal material production configuration for the production of a reduced metal material resistant to re-oxidation.

The present disclosure may relate to a direct reduction facility configured to produce a carbon-free reduced metal material that is resistant to re-oxidation.

The present invention further relates to a data program adapted to control the operation of the metal material production configuration.

The present invention primarily concerns the mining industry and industries making reduced metal material, and concerns manufacturers and suppliers of metal material production configurations and metal oxide material production units, direct reduction facilities, metal making industries, high-temperature electrolysis units, data program providers etc.

### BACKGROUND OF THE INVENTION

Current technologies for producing a reduced metal material may use different solutions to prevent re-oxidation of the produced reduced metal material.

Current technologies aim to provide energy efficient production of reduced metal material resistant to re-oxidation.

Current technologies aim to provide energy efficient direct reduction of metal oxide material making use of hydrogen, which hydrogen entirely or partly is produced by electrolysis of water using fossil free and/or renewable energy.

Current technology may use hydrogen for direct reduction of metal oxide material instead of using carbonaceous reducing agents, such as natural gas. One example is the HYBRIT™ concept that proposes hydrogen direct reduction H-DR using hydrogen produced by electrolysis of water by utilizing fossil free and renewable energy.

Energy saving and cost-effective production of direct reduced metal material resistant to re-oxidation also being found in the IronDrop™ concept. The IronDrop™ concept is developed by LKAB and aims to make use of fossil free and/or renewable energy in energy efficient production of reduced metal material that is resistant to re-oxidation. The IronDrop™ initiative also aims to develop current technologies in the production of sponge iron resistant to re-oxidation.

The direct reduction of the metal oxide material by means of the introduced hydrogen containing reducing agent requires a high reaction temperature for providing the chemical reaction for the direct reduction process in the direct reduction facility.

### SUMMARY OF THE INVENTION

The IronDrop™ concept operates efficiently, but there is an object to further develop the IronDrop™ technology and to provide new solutions in current technologies that use hydrogen for direct reduction of metal oxide material.

There is an object to provide energy efficient production of reduced metal material resistant that is treated to obtain resistance to re-oxidation before being discharged from the direct reduction facility.

There is an object to provide efficient direct reduction of the metal oxide material at the same time as efficient control of the production of reduced metal material resistant to re-oxidation is established.

There is an object to provide efficient use of hydrogen in the production of reduced metal material resistant to re-oxidation, which production makes use of hydrogen generated by utilization of fossil free and/or renewable energy.

There is an object to provide cost-efficient transportation supply chains for transportation of reduced metal material to other industries, such as metal making industries.

There is an object to provide production of an intermediate product resistant to re-oxidation to be used in cost-efficient production of metal material, such as steel.

There is an object to provide a method for producing a reduced metal material resistant to re-oxidation on an industrial scale, in a CO2-neutral and/or CO2-low emission and/or CO2 free fashion.

There an object to provide is a carbon free reduced metal material resistant to re-oxidation by an energy efficient direct reduction process.

There is an object to produce a substantially fully metallized reduced metal material, wherein the reduced metal material is reduced greater than about 90%, preferably about 95-100%, thereby decreasing hydrogen accumulation and/or the hydrogen content of the top gas in the direct reduction facility.

There is an object to produce a substantially fully metallized reduced metal material, wherein the reduced metal material is reduced greater than about 75%.

There in an object to simplify treatment of a top gas (generated by the chemical reaction in the direct reduction facility) removed from the direct reduction facility and to provide efficient re-cycling of the top gas.

There is an object to provide efficient direct reduction of the metal oxide material at the same time as efficient control of the production of reduced metal material is established.

These or at least one of said objects has been achieved by a method of direct reduction of a metal oxide material holding a first thermal energy into a reduced metal material by means of a metal material production configuration; wherein the metal oxide material, holding the first thermal energy, is provided by a metal oxide material provider unit; the method comprises the steps of; charging the metal oxide material holding the first thermal energy into a direct reduction facility via a metal oxide material charging inlet device; introducing a pre-heated hydrogen containing reducing agent, holding a second thermal energy, into the direct reduction facility via a reducing agent inlet device; reducing the metal oxide material by using the first thermal energy of the metal oxide material to heat or further heat the introduced pre-heated hydrogen containing reducing agent for providing a chemical reaction between the introduced pre-heated hydrogen containing reducing agent and the metal oxide material; exposing the reduced metal material to a required heat treatment temperature for providing heat treatment of the reduced metal material to obtain a densified reduced metal material; upholding the required heat treatment temperature by the introduction of the pre-heated hydrogen containing reducing agent by means of a heat treatment providing device; and discharging the reduced metal material that has been subjected to heat treatment.

Alternatively, the method comprises the further step of; introducing a pre-heated hydrogen containing heat treatment agent holding a third thermal energy into the direct reduction facility by means of a heat treatment agent feeding device for exposing the reduced metal material to the required heat treatment temperature for upholding the required heat treatment temperature and for said heat treatment of the reduced metal material to obtain the densified reduced metal material.

Alternatively, a reducing agent inlet of the reducing agent inlet device configured to introduce the pre-heated hydrogen containing reducing agent into the direct reduction facility is positioned higher up in the direct reduction facility than a heat treatment agent inlet of the heat treatment agent feeding device configured to introduce the pre-heated hydrogen containing heat treatment agent.

In such way is achieved that the cooling rate of the reduced metal material descending through the direct reduction facility is decreased enabling an effective heat treatment of the reduced metal material.

Alternatively, the heat treatment agent feeding device comprises a heat treatment agent pre-heating unit configured to pre-heat the hydrogen containing heat treatment agent to reach the third thermal energy before being introduced into the direct reduction facility.

Alternatively, the heat treatment agent feeding device is configured for introduction of the hydrogen containing heat treatment agent holding the third thermal energy.

Alternatively, the heat treatment of the reduced metal material is achieved by the introduction of the pre-heated hydrogen containing heat treatment agent into the direct reduction facility, wherein the third thermal energy is increased by means of the heat treatment agent feeding device in order to decrease the rate of cooling down the reduced metal material in the direct reduction facility.

Alternatively, the control circuitry is electrically coupled to a heat treatment agent thermal energy adjusting device of the heat treatment agent feeding device to adjust the third thermal energy of the hydrogen containing heat treatment agent for controlling the heat treatment of the reduced metal material.

Alternatively, the heat treatment of the reduced metal material is achieved by using the third thermal energy of the hydrogen containing heat treatment agent for providing metal particle shrinkage of the reduced metal material.

The pre-heated hydrogen containing heat treatment agent comprises about 80-100% hydrogen, preferably about 100% hydrogen by volume, or about 60-80% hydrogen by volume, preferably about 65-75% hydrogen by volume.

Alternatively, the step of upholding the required heat treatment temperature is provided to such extent that the introduction of the pre-heated hydrogen generates the direct reduction of the metal oxide material and decreases the cooling rate of the reduced metal material descending through the direct reduction facility for maintaining said required heat treatment temperature.

Alternatively, the metal oxide material comprises an iron ore oxide material subject to direct reduction into a reduced iron ore material, wherein a wüstite material of the iron oxide material subject to reduction would to great extent be reduced into an iron material; due to the high content of a hydrogen gas of the introduced pre-heated hydrogen containing reducing agent and/or the hydrogen containing heat treatment agent, and due to the second thermal energy of the pre-heated hydrogen containing reducing agent and/or due to the third thermal energy pre-heated hydrogen containing heat treatment agent.

Alternatively, the direct reduction facility is configured to permit the reduced metal material to descend and brought into contact with the pre-heated hydrogen containing reducing agent and/or the pre-heated hydrogen containing heat treatment agent, for providing said heat treatment.

Alternatively, the cooling rate of the reduced metal material descending through the direct reduction facility is controlled by the control circuitry by adjusting the temperature of the hydrogen containing reducing agent and/or by adjusting the mass flow of the hydrogen containing reducing agent fed into the direct reduction facility.

Alternatively, the cooling rate of the reduced metal material descending through the direct reduction facility is controlled by the control circuitry by adjusting the temperature of the hydrogen containing heat treatment agent and/or by adjusting the mass flow of the hydrogen containing heat treatment agent fed into the direct reduction facility.

In such way is achieved a decreased cooling rate adapted for cooling the reduced metal material in the direct reduction facility providing said heat treatment of the reduced metal material, whereby the reduced and heat treated reduced metal material will form compact and dense reduced metal material (agglomerates), wherein the each reduced metal agglomerate exhibits a compact and dense structure resistant to re-oxidation.

In such way is achieved that the heat energy of the reduced metal material is maintained further down in the direct reduction facility for proving said heat treatment.

Alternatively, the method comprises pre-heating the hydrogen containing reducing agent to be introduced into the direct reduction facility by means of a reducing agent pre-heating device of the heat treatment providing device for reaching the required heat treatment temperature.

Alternatively, the introducing of the hydrogen containing reducing agent, holding the second thermal energy, is preceded by a step of pre-heating the hydrogen containing reducing agent to such extent that the second thermal energy of the introduced hydrogen containing reducing agent does not exceed the first thermal energy of the metal oxide material being charged into the direct reduction facility.

Alternatively, the step of upholding the required heat treatment temperature comprises; adjusting the second thermal energy by means of a reducing agent thermal energy adjusting device electrically coupled to a first control circuitry configured to operate the reducing agent thermal energy adjusting device for controlling the required heat treatment temperature.

Alternatively, the step of upholding the required heat treatment temperature comprises; adjusting the mass flow of the hydrogen containing reducing agent introduced into the direct reduction facility by means of a reducing agent mass flow adjusting device electrically coupled to a second control circuitry configured to operate the reducing agent mass flow adjusting device for controlling the required heat treatment temperature.

Alternatively, the step of upholding the required heat treatment temperature comprises; adjusting a residence time period for keeping the reduced metal material during a specific residence time period in the direct reduction facility by means of a residence time period adjusting device electrically coupled to a third control circuitry configured to operate the residence time period adjusting device for achieving a specific residence time period and controlling the required heat treatment temperature.

Alternatively, the step of providing the required heat treatment temperature comprises; adjusting pressurization of the interior of the direct reduction facility by means of a pressurization adjusting device electrically coupled to a fourth control circuitry configured to operate the pressurization adjusting device for controlling the required heat treatment temperature.

Alternatively, the pressurization adjusting device comprises a reducing agent introduction/pressurizing device and/or a top gas removing device and/or by regulating the mass flow top gas removed from the direct reduction facility.

Alternatively, the reducing agent introduction/pressurizing device comprises a reducing pressurizing gas pump.

Alternatively, the top gas removing device comprises a top gas suction pump.

Alternatively, the pressurization of the interior of the direct reduction facility is achieved by the introduction of the hydrogen containing reducing agent and/or by regulating the mass flow of the top gas removed from the direct reduction facility.

Alternatively, the direct reduction is performed in the direct reduction facility at a pressure of from about 1 Bar to about 10 Bar; preferably from 3 Bar to about 8 Bar.

Alternatively, the direct reduction is performed in the direct reduction facility at a pressure of from about 4 Bar to about 14 Bar; preferably from 6 Bar to about 12 Bar.

Alternatively, the direct reduction is performed in the direct reduction facility at a pressure below 1 Bar.

Alternatively, a fifth control circuitry is adapted for operating the heat treatment agent pre-heating unit to adjust the third thermal energy of the pre-heated hydrogen containing heat treatment agent for exposing the reduced metal material to the required heat treatment temperature for providing heat treatment of the reduced metal material to obtain a densified reduced metal material and for upholding the required heat treatment temperature.

These or at least one of said objects has been achieved by a metal material production configuration adapted for direct reduction of a metal oxide material holding a first thermal energy into a reduced metal material; the metal material production configuration comprises; a metal oxide material provider unit configured to provide the metal oxide material holding the first thermal energy; a direct reduction facility comprising; a metal oxide material charging inlet device; a reducing agent inlet device (B) configured to introduce a hydrogen containing reducing agent holding a second thermal energy, a direct reduction zone of the direct reduction facility configured to reduce the metal oxide material by using the first thermal energy of the metal oxide material to heat or further heat the introduced hydrogen containing reducing agent for providing a chemical reaction between the introduced hydrogen containing reducing agent and the metal oxide material; a heat treatment zone of the direct reduction facility configured for heat treatment of the reduced metal material by exposing the reduced metal material to a required heat treatment temperature for providing heat treatment of the reduced metal material to obtain a densified reduced metal material; a heat treatment providing device configured for upholding the required heat treatment temperature by the introduction of the pre-heated hydrogen containing reducing agent; and a reduced metal material discharge device configured to discharge the reduced metal material that has been subjected to heat treatment.

Alternatively, the reduced metal material discharge device comprises a metal material outlet configured to discharge the heat treated and reduced metal material from the direct reduction facility.

Alternatively, the metal material production configuration further comprises a reducing agent pre-heating device of the heat treatment providing device adapted to pre-heat the hydrogen containing reducing agent to be introduced into the direct reduction facility.

Alternatively, the heat treatment providing device comprises a reducing agent thermal energy adjusting device configured to adjust the second thermal energy; and a first control circuitry electrically coupled to the reducing agent thermal energy adjusting device and configured to control the reducing agent thermal energy adjusting device for reaching the required heat treatment temperature.

Alternatively, the reducing agent thermal energy adjusting device comprises an electric pre-heater configured to pre-heat the hydrogen containing reducing agent.

Alternatively, the heat treatment providing device comprises a reducing agent mass flow adjusting device configured to adjust the mass flow of the hydrogen containing reducing agent introduced into the direct reduction facility; and a second control circuitry electrically coupled to the reducing agent mass flow adjusting device and configured to operate the reducing agent mass flow adjusting device to adjust the mass flow of the hydrogen containing reducing agent for reaching the required heat treatment temperature.

Alternatively, the heat treatment providing device comprises a residence time period adjusting device configured to adjust a residence time period for keeping the reduced metal material in the direct reduction facility; and a third control circuitry electrically coupled to the residence time period adjusting device and configured to operate the residence time period adjusting device for achieving said specific residence time period and controlling the required heat treatment temperature.

Alternatively, the heat treatment providing device comprises a pressurization adjusting device configured to adjust pressurization of the interior of the direct reduction facility; and a fourth control circuitry electrically coupled to the pressurization adjusting device and configured to operate the pressurization adjusting device for controlling the required heat treatment temperature.

Alternatively, the direct reduction facility comprises a top gas removing device configured to remove a top gas from the direct reduction facility.

Alternatively, the top gas contains up to about 100 vol. % high-temperature water steam.

Alternatively, the top gas contains up to about 80-100 vol. %, preferably about 85-95 vol. %, high-temperature water steam.

Alternatively, the top gas contains up to about 60-90 vol. %, preferably about 70-80 vol. %, high-temperature water steam.

Alternatively, the top gas contains up to about 40-80 vol. %, preferably about 50-70 vol. %, high-temperature water steam.

Alternatively, the top gas contains up to about 20-60 vol. %, preferably about 30-40 vol. %, high-temperature water steam.

Alternatively, the top gas contains up to about 15-35 vol. %, preferably about 20-30 vol. %, high-temperature water steam.

Alternatively, the top gas comprises the high-temperature water steam and an excess hydrogen gas.

Alternatively, the excess hydrogen gas being separated from the high-temperature top gas and is re-circulated to the direct reduction facility and introduced into the direct reduction facility.

In such way a cost-effective use of hydrogen gas is achieved.

Alternatively, the high-temperature water steam exhibits a temperature of about 600° C. to about 1200° C., preferably at about 700° C. to about 1100° C.

Alternatively, the high-temperature water steam exhibits a temperature of about 700° C. to about 1450° C., preferably at about 800° C. to about 1350° C.

Alternatively, the required reaction temperature for maintaining the direct reduction in the direct reduction facility may be at temperatures of from about 800° C. to about 1200° C., preferably about 900° C. to about 1100° C.

Alternatively, the required reaction temperature for maintaining the direct reduction in the direct reduction facility may be at temperatures of from about 600° C. to about 1400° C., preferably about 850° C. to about 1250° C.

Alternatively, the upper interior portion is configured for enabling a required reaction temperature that is higher than the required reaction temperature provided by the lower interior portion.

### Hydrogen Containing Reducing Agent Temperature

Alternatively, the hydrogen containing reducing agent being introduced into the direct reduction facility exhibits a temperature of about 200° C. to about 700° C., preferably about 300° C. to about 600° C.

Alternatively, the hydrogen gas containing reducing agent that is fed into the direct reduction facility may exhibit a temperature of about 350° C. to about 900° C., preferably about 450° C. to about 750° C.

Alternatively, the hydrogen gas containing reducing agent being introduced into the direct reduction facility exhibits a temperature of about 400° C. to about 950° C., preferably about 550° C. to about 800° C.

Alternatively, the hydrogen gas containing reducing agent being introduced into the direct reduction facility exhibits a temperature of about 600° C. to about 1200° C., preferably about 850° C. to about 950° C.

Alternatively, a complementary hydrogen containing reducing agent being introduced into the direct reduction facility exhibit a temperature of about 200° C. to about 700° C., preferably about 300° C. to about 600° C.

Alternatively, the complementary hydrogen containing reducing agent is introduced into the direct reduction facility at a level below the introduction of the hydrogen gas containing reducing agent being introduced into the direct reduction facility.

Alternatively, a cooling gas comprising hydrogen may be introduced into the lower interior portion of the direct reduction facility for cost-effective management of cooled down reduced metal material discharged from the direct reduction facility.

### Metal Oxide Material Temperature

Alternatively, the metal oxide material holding thermal energy being charged into the direct reduction facility exhibits a temperature of 800° C. to about 1200° C., preferably about 900° C. to about 1100° C.

Alternatively, the metal oxide material holding the first thermal energy being charged into the direct reduction facility exhibits a temperature of 900° C. to about 1300° C., preferably about 1000° C. to about 1200° C.

Alternatively, the metal oxide material holding thermal energy being charged into the direct reduction facility exhibits a temperature of 1000° C. to about 1450° C., preferably about 1100°C. to about 1300° C.

In such way is achieved an efficient heat recovery that may be utilized by a high-temperature electrolysis unit.

Alternatively, the top gas comprises the water steam generated by the chemical reaction between the metal oxide material and hydrogen of the hydrogen containing reducing agent.

Alternatively, the top gas comprises hydrogen not being consumed by the chemical reaction between the metal oxide material and hydrogen of the hydrogen containing reducing agent.

Alternatively, the continuously introduction of the hydrogen containing reducing agent is of such amount that the top gas removed from the direct reduction facility always comprises hydrogen.

In such way is guaranteed that hydrogen is available in the direct reduction facility for achieving the chemical reaction.

Alternatively, the introduced pre-heated hydrogen containing reducing agent comprises about 80-100% hydrogen, preferably about 100% hydrogen by volume.

Alternatively, the pre-heated hydrogen containing reducing agent introduced into the direct reduction facility comprises greater than about 70 vol. % hydrogen gas.

Alternatively, the pre-heated hydrogen containing reducing agent introduced into the direct reduction facility comprises about 40 vol. % to about 80 vol. % hydrogen gas, preferably about 50 vol. % to about 70 vol. % hydrogen gas.

Alternatively, the pre-heated hydrogen gas containing reducing agent introduced into the direct reduction facility comprises about 60 vol. % to about 100 vol. % hydrogen gas, preferably about 70 vol. % to about 90 vol. % hydrogen gas.

Alternatively, the pre-heated hydrogen containing reducing agent comprises about 60-80% hydrogen by volume, preferably about 65-75% hydrogen by volume.

These or at least one of said objects has been achieved by a data program comprising a program code readable on a computer of a control circuitry of the metal material production configuration according to any of the metal material production configuration claims, which data program is programmed for causing the heat treatment providing device to uphold the required heat treatment temperature by the introduction of the pre-heated hydrogen containing reducing agent.

Alternatively, the control circuitry comprises the first control circuitry, the second control circuitry, the third control circuitry, the fourth control circuitry and the fifth control circuitry.

These or at least one of said objects has been achieved by a product produced according to any of the method steps, wherein the reduced metal material comprises reduced iron ore particles bond to each other forming heat treated and/or heat hardened reduced metal material.

Alternatively, the lower interior portion of the direct reduction facility comprises the metal material outlet configured to discharge the heat treated, reduced metal material from the direct reduction facility.

Alternatively, the control circuitry is adapted to adjust the second thermal energy toward a required reaction temperature for providing a complete reduction.

In such way is achieved a densifying process for densifying the direct reduced metal material, which thereby is prevented from re-oxidation in turn enabling secure and cost-effective transportation of the reduced metal material, such as an intermediate product, to e.g. a metal making industry.

Alternatively, the separation unit is configured to separate the excess hydrogen gas from the high-temperature top gas.

By using the first thermal energy of the metal oxide material produced by the metal oxide material provider unit for providing the direct reduction (fully or partially or substantially) in the reduction facility, there is no need to heat the hydrogen containing reducing agent to a very high temperature by exothermic partial oxidation of the hydrogen containing reducing agent with oxygen or air, for reaching the required reaction temperature.

In such way is achieved that chemical reactivity and/or high impetus of the hydrogen containing reducing agent is maintained when introduced into the direct reduction facility, at the same time as the heat treatment produces a compact and dense reduced metal material resistant to re-oxidation.

The chemical reactivity and/or high impetus being essential for providing an efficient direct reduction of the metal oxide material.

In such way is achieved that the reduction potential of the hydrogen containing reducing agent is maintained for achieving efficient direct reduction and heat treatment.

Alternatively, the relatively high temperature of the metal oxide material charged into the direct reduction facility, and the second thermal energy of the pre-heated hydrogen containing reducing agent, will result in an energy efficient direct reduction of the metal oxide material into the reduced metal material at the required reaction temperature.

Alternatively, the required reaction temperature for providing an efficient direct reduction in the direct reduction facility may be at temperatures of from about 800° C. to about 1200° C., preferably about 900° C. to about 1100° C., or may be at temperatures of from about 700° C. to about 1400° C., preferably about 950° C. to about 1200° C., or may be at temperatures of from about 600° C. to about 1500° C., preferably about 800° C. to about 1200° C.

Alternatively, the required reaction temperature is upheld by pre-heating the hydrogen containing reducing agent to be introduced into the direct reduction facility and utilizing the high temperature of the metal oxide material, holding the first thermal energy.

Alternatively, the reducing agent pre-heating device of the heat treatment providing device comprises a reducing gas pre-heater, such as an electric reducing gas pre-heater.

Alternatively, the control circuitry is adapted to operate the reducing agent mass flow adjusting device to increase the mass flow of the hydrogen containing reducing agent (H) introduced into the direct reduction facility and is adapted to operate the reducing agent thermal energy adjusting device to decrease the second thermal energy of the hydrogen containing reducing agent for reaching the required heat treatment temperature.

Alternatively, the chemical reaction comprises a substantially or completely endothermal chemical reaction that consumes thermal energy equivalent to about 475-525° C., preferably about 500° C., which energy is provided by the metal oxide material holding the first thermal energy during the reduction prior the heat treatment of the reduced metal material to obtain the densified reduced metal material

Alternatively, the heat treatment temperature is adapted to be within the range of 200-600°C., preferably 300-500° C.

Alternatively, the heat treatment temperature is adapted to be within the range of 300-800°C., preferably 400-600° C.

Alternatively, the temperature of the metal oxide material holding the first thermal energy is achieved by means of the metal oxide material provider unit, such as a metal oxide pelletizing apparatus, configured to produce the metal oxide material holding the first thermal energy or substantially the first thermal energy.

Alternatively, a metal ore material is dried and then pre-heated in a pre-heating zone of the metal oxide pelletizing apparatus, which pre-heating zone is configured to pre-heat the metal ore material into pre-heated metal ore material.

Alternatively, the metal ore material may be in the form of iron ore pellets (e.g. green pellets).

Alternatively, the pre-heated metal ore material is transferred into an induration zone of the metal oxide pelletizing apparatus, which induration zone is configured to indurate the pre-heated metal ore material.

Alternatively, the induration zone comprises an oxidation zone configured for oxidation of the pre-heated metal ore material and/or a sintering zone for sintering the oxidized pre-heated metal ore material.

Alternatively, the hydrogen of the hydrogen containing reducing agent and/or the hydrogen of the hydrogen containing heat treatment agent being produced by means of an electrolysis unit and/or a high temperature electrolysis unit configured to decompose water into hydrogen and oxygen.

Alternatively, the electrolysis unit and/or the high temperature electrolysis unit being configured to decompose water into hydrogen and oxygen and being electrically supplied by a re-generative energy supply.

Alternatively, the oxygen produced by the electrolysis unit and/or the high temperature electrolysis unit is transferred into the oxidation zone for oxidation of the pre-heated metal ore material.

Alternatively, the induration zone is configured to indurate the pre-heated metal ore material toward a temperature of about 1000° C. to about 1450° C., preferably about 1100° C. to about 1300° C., for producing the metal oxide material holding heat energy corresponding substantially to the first thermal energy.

Alternatively, the metal oxide material is discharged from the metal oxide pelletizing apparatus, and in connection therewith, the metal oxide material holds heat energy provided by the metal oxide pelletizing apparatus and is charged directly into the direct reduction facility, wherein the metal oxide material holds heat energy substantially corresponds to the first thermal energy.

Alternatively, the temperature of the metal oxide material holding thermal energy is achieved by means of the metal oxide material provider unit, such as a metal oxide material pre-heating device, configured to pre-heat previously cooled down metal oxide material holding the heat energy, for producing the metal oxide material holding the first thermal energy.

Alternatively, the temperature of the metal oxide material holding the first thermal energy is achieved by means of the metal oxide material pre-heating device configured to pre-heat metal oxide material to a temperature of about 1000° C. to about 1450° C., preferably about 1100° C. to about 1300° C., for the production of the metal oxide material holding thermal energy.

Alternatively, the temperature of the metal oxide material holding the first thermal energy is achieved by means of the metal oxide material pre-heating device configured to pre-heat metal oxide material to a temperature of about 900° C. to about 1350° C., preferably about 1000° C. to about 1200° C., for the production of the metal oxide material holding the first thermal energy.

Alternatively, metal oxide material pre-heating device is configured to pre-heat the metal oxide material to a heat energy substantially corresponding to the first thermal energy.

Alternatively, metal oxide material pre-heating device is coupled to the metal oxide material charging inlet device via a metal oxide material transfer device.

Alternatively, the metal oxide material transfer device is configured to cool down the pre-heated metal oxide material.

Alternatively, the metal oxide material transfer device comprises a charging hopper arrangement associated with the upper interior portion of the direct reduction facility

Alternatively, the metal oxide material is discharged from the metal oxide material pre-heating device for achieving substantially the first thermal energy and is charged directly into the direct reduction facility.

Alternatively, the metal oxide material holding the thermal heat is discharged from the metal oxide material provider unit and is charged via a metal oxide material cooler unit into the direct reduction facility for providing the first thermal energy.

Alternatively, the charging hopper arrangement is configured to introduce a first seal gas into the direct reduction facility in conjunction with charging the metal oxide material holding the thermal energy into the direct reduction facility.

Alternatively, the first seal gas and/or the second seal gas comprise/s an inert gas.

In such way is achieved that formation of explosive air/process gas mixtures are avoided when charging the metal oxide material holding thermal energy into the direct reduction facility.

Alternatively, the first seal gas comprises carbon dioxide gas for providing a carburized reduced metal material.

Alternatively, the metal oxide material, holding the thermal heat and being discharged from the metal oxide material provider unit, is cooled down by means of the metal oxide material cooler unit configured to cool down the metal oxide material for adapting the first thermal energy of the metal oxide material, before charging it into the direct reduction facility, toward a temperature that efficiently increases the temperature of the hydrogen containing reducing agent for maintaining the required reaction temperature for the direct reduction.

Alternatively, the chemical reaction comprises direct reduction of the metal oxide material into the reduced metal material.

Alternatively, the direct reduction facility is formed as a solid-gas counter-current moving bed reactor, wherein the metal oxide material holding the first thermal energy is charged into the upper interior portion of the direct reduction facility via the metal oxide material charging inlet device and descends by gravity toward a lower interior portion of the direct reduction facility, wherein the pre-heated hydrogen containing reducing agent, holding the second thermal energy, introduced into the direct reduction facility (e.g. an upper interior portion and/or an intermediate interior portion and/or a lower interior portion of the direct reduction facility) reduces the metal oxide material.

Alternatively, the introduction of the pre-heated hydrogen containing reducing agent is provided at a position that is below the metal oxide material charging inlet device.

Alternatively, the heat energy of the introduced pre-heated hydrogen containing reducing agent is adjusted toward the second thermal energy by means of the reducing agent thermal energy adjusting device.

Alternatively, the control circuitry is adapted to control the chemical reaction between the hydrogen containing reducing agent and the metal oxide material, and/or adapted to control the heat treatment of the reduced metal material, by adjusting the second thermal energy of the hydrogen containing reducing agent to be introduced into the direct reduction facility by means of the reducing agent thermal energy adjusting device and/or by adjusting the mass flow of the hydrogen containing reducing agent into the direct reduction facility by means of the reducing agent mass flow adjusting device configured to and/or by adjusting the residence time period of the reduced metal material in the direct reduction facility by means of the residence time period adjusting apparatus of the direct reduction facility and/or adjusting the third thermal energy of the pre-heated hydrogen containing heat treatment agent by means of the heat treatment agent feeding device.

Alternatively, the hydrogen containing reducing agent is utilized for heat treatment of the reduced metal material and/or the metal oxide material subject to reduction.

Alternatively, the introduction of the hydrogen containing reducing agent is provided to such extent that excess of hydrogen resides in the interior of the direct reduction facility subsequently said chemical reaction for enabling the complete and/or substantially complete reduction of the metal oxide material holding the first thermal energy.

Alternatively, the residence time period adjusting device comprises a discharge feeder device, such as a vibrating discharge feeder, screw discharge feeder, hopper discharge feeder etc., coupled to the metal material outlet of the lower interior portion of the direct reduction facility.

Alternatively, a second seal gas is introduced into the direct reduction facility via the discharge feeder device in conjunction with discharging the reduced metal material from the direct reduction facility.

In such way is achieved that formation of explosive air/process gas mixtures are avoided when discharging the reduced metal material from the direct reduction facility.

Alternatively, the metal oxide material to be charged into the direct reduction facility is in the form of metal oxide pellets structurally formed by metal oxide particles.

Alternatively, the metal oxide material subject to reduction is in the form of metal oxide pellets structurally formed by metal oxide particles subject to reduction.

Alternatively, the reduced metal material is in the form of reduced metal pellets structurally formed by reduced metal particles.

Alternatively, the Hight-to-Width ratio of the interior of the direct reduction facility is greater than at least 1:1 up to 10:1 for achieving a residence time period suitable for said heat treatment of the reduced metal material at the same time as the flow of metal oxide material subject to reduction and/or the flow of reduced metal material through the interior of the direct reduction facility can be held high enough to avoid sticking of metal particles of the reduced metal material in the direct reduction facility.

Alternatively, the direct reduction facility and/or the metal oxide material provider unit and/or the control circuitry and/or the electrolysis unit and/or the high temperature electrolysis unit being part/s of a metal material production configuration.

Alternatively, the introduction the hydrogen containing reducing agent, holding the second thermal energy, is made into an intermediate interior portion of the direct reduction facility.

Alternatively, the metal material production configuration comprises a top gas recycling arrangement adapted to recycle a proportion of the top gas and mixing it with the hydrogen produced by the electrolysis unit and/or the high temperature electrolysis unit to form the hydrogen containing reducing agent and/or the hydrogen containing heat treatment agent.

Alternatively, the step of reducing the metal oxide material holding the first thermal energy in the upper interior portion is achieved by utilizing the first thermal energy of the metal oxide material and by utilizing thermal energy of partly reduced metal material in the upper interior portion to heat or further heat the introduced pre-heated hydrogen.

By charging the metal oxide material from the metal oxide material provider unit directly into the direct reduction facility, which metal oxide material holds the first thermal energy that originates from the metal oxide material provider unit, the reduction and the chemical reaction between the metal oxide material and the hydrogen containing reducing agent can be provided energy efficient, at the same time as the hydrogen of the hydrogen containing reducing agent will maintain its reduction potential.

In such way is eliminated the need of further heating of the hydrogen containing reducing agent by means of exothermic partial oxidation of the hydrogen containing reducing agent with oxygen or air, which destroys the reduction potential.

Alternatively, the upper interior portion of the direct reduction facility is configured for direct reduction of the metal oxide material holding the first thermal energy.

Alternatively, the control circuitry is electrically coupled to the heat treatment providing device, and coupled to the reducing agent thermal energy adjusting device and/or the reducing agent mass flow adjusting device and/or the residence time period adjusting device and/or the pressurization adjusting device and/or the heat treatment agent feeding device configured for introduction of a hydrogen containing heat treatment agent holding a third thermal energy adapted for said heat treatment.

Alternatively, the direct reduction facility is provided to allow the reduced metal material to descend to the lower interior portion of the direct reduction facility for exposing the reduced metal material to a required heat treatment temperature for providing said heat treatment of the reduced metal material and for upholding the required heat treatment temperature by the introduction of the pre-heated hydrogen containing reducing agent.

Alternatively, the direct reduction facility comprises a heat treatment agent introduction device configured to introduce the hydrogen containing heat treatment agent, which heat treatment agent introduction device is coupled to the control circuitry.

Alternatively, the direct reduction facility comprises a heat treatment agent feeding device configured to introduce pre-heated hydrogen containing heat treatment agent, which heat treatment agent feeding device is electrically coupled to the control circuitry.

Alternatively, the heat treatment agent introduction device comprises a heat treatment agent pre-heater electrically coupled to the control circuitry adapted to control the temperature of the thermal heat of the hydrogen containing heat treatment agent added to the reduced metal material.

Alternatively, the metal oxide material holding the first thermal energy is permitted to continuously descend within the direct reduction facility and thus brought into contact with the continuously introduced pre-heated hydrogen containing reducing agent holding the second thermal energy, for providing the reduction of the metal oxide material into reduced metal material.

Alternatively, the metal oxide material subject to reduction and/or the reduced metal material is permitted to descend within the direct reduction facility and thus brought into contact with the hydrogen containing heat treatment agent for providing said heat treatment within the direct reduction facility.

Alternatively, the exposing of the reduced metal material to a required heat treatment temperature for providing heat treatment of the reduced metal material produces the densified reduced metal material and/or semi-molten reduced metal material and/or passivated reduced metal material.

In such way is achieved that the reduced metal material discharged from the direct reduction facility forms an intermediate product that is resistant to re-oxidation.

In such way is provide a cost-efficient transport to a metal making industry, such as steel making industry.

In such way is achieved that the produced intermediate product (e.g. sponge iron or IronDrop™) can be used in energy efficient “green” production of steel.

Alternatively, the metal oxide material subject to reduction and/or the reduced metal material is permitted to descend and brought into contact with the hydrogen containing heat treatment agent for providing said heat treatment, wherein the control circuitry is adapted to control the thermal energy of the hydrogen containing heat treatment agent in such way that the temperature of the reduced metal material decreases the farther down the reduced metal material descends in the direct reduction facility

In such way is guaranteed that the chemical reaction (substantially an endothermal reaction) is energy efficient by using the first thermal energy for reaching the required reaction temperature and the reduction potential of the pre-heated hydrogen containing reducing agent is maintained further saving energy.

In such way, the first thermal energy of the metal oxide material can be used to a great extent by its high content of thermal energy used for the reduction in the upper interior portion, where the metal oxide material holding said first thermal energy initially meets the hydrogen containing reducing agent for direct reducing the metal oxide material by using the first thermal energy of the metal oxide material to heat or further heat the introduced hydrogen containing reducing agent for providing a chemical reaction between the introduced hydrogen containing reducing agent and the metal oxide material.

Alternatively, the pre-heated hydrogen containing reducing agent and/or the pre-heated hydrogen containing heat treatment agent introduced into the direct reduction facility being provided for producing a semi-molten reduced metal material and/or a densified reduced metal material.

In such a way is prevented de-gradation of the reduced metal material.

Alternatively, the direct reduction facility comprises a heat treatment agent feeding device positioned at a level below the reducing agent inlet device, which heat treatment agent feeding device is configured for introduction of a hydrogen containing heat treatment agent holding a third thermal energy, wherein the control circuitry is adapted for adjusting the third thermal energy for providing the heat treatment to produce a semi-molten and/or densified reduced metal material.

Alternatively, the control circuitry is adapted to operate the reducing agent temperature regulator to cause the second thermal energy of the hydrogen containing reducing agent for providing the required reaction temperature for said direct reduction and/or for providing said required heat treatment temperature.

Alternatively, the direct reduction facility comprises a metal material outlet configured to discharge the reduced metal material that has been heat treated from the direct reduction facility.

Alternatively, the direct reduction facility comprises a top gas removing device configured to remove a top gas from the direct reduction facility.

Alternatively, the metal ore material comprises iron ore material.

Alternatively, the iron ore material comprises hematite material and magnetite material.

Alternatively, the pre-heated metal ore material comprises pre-heated iron ore material.

Alternatively, the metal oxide material comprises iron ore oxide material.

Alternatively, the reduced and heat treated metal material comprises reduced and heat treated iron ore material.

Alternatively, the metal oxide material is formed as metal oxide agglomerates.

Alternatively, the reduced and heat treated metal material is formed as reduced metal agglomerates.

Alternatively, a reduced and heat treated metal agglomerate exhibits a densified surface area.

Alternatively, a reduced metal agglomerate is formed of reduced metal particles.

Alternatively, a reduced and heat treated metal agglomerate exhibits a densified surface area of merged reduced metal particles covering a porous core of reduced metal particles.

Alternatively, the reduced and heat treated metal agglomerate consists of merged reduced metal particles.

The expression “reducing” or “reduction” may be changed to “direct reducing” or “direct reduction”.

Alternatively, the method further comprises the steps of decomposing water into electrolytic hydrogen and oxygen by means of an electrolysis unit; producing methanol by reacting the electrolytic hydrogen with carbon dioxide; storing the methanol; reforming the methanol by using water and/or oxygen to provide carbon dioxide and released hydrogen; providing the released hydrogen as a component of the pre-heated hydrogen containing reducing agent into the direct reduction facility; and providing the step of introducing the pre-heated hydrogen containing reducing agent, holding the second thermal energy, into the direct reduction facility via the reducing agent inlet device.

In such way is achieved means to buffer energy in the form of methanol to be used in said reforming step when the method is to be applied. This means that during times of high electricity cost and/or low renewable electricity supply, the hydrogen may be produced by said reforming step.

Alternatively, the method comprises the further step of charging the metal oxide material holding the first thermal energy into the direct reduction facility via the metal oxide material charging inlet device is provided in conjunction with introduction of a first seal gas; and/or the step of discharging the reduced metal material is provided in conjunction with introduction of a second seal gas.

In such way is achieved that the charging of the metal oxide material into the direct reduction facility can be made safely without any formations of explosive air/process gas mixtures when the charging proceeds.

This is achieved by ensuring that only the seal gas, and not air, is introduced into the direct reduction facility when charging metal oxide material, wherein no process gas and/or hydrogen containing reducing gas escapes the direct reduction facility during the charging.

Alternatively, a charging arrangement of the metal oxide material charging inlet device is configured to transfer the metal oxide material holding the first thermal energy into the direct reduction facility from the metal oxide material provider unit.

Alternatively, the charging arrangement comprises a seal gas introduction device configured to introduce the seal gas into the direct reduction facility.

Alternatively, the direct reduction facility is provided as a solid-gas counter-current moving bed reactor.

Alternatively, the direct reduction is performed in the direct reduction facility at a first pressure, wherein the seal gas introduction device is configured to introduce the seal gas into the direct reduction facility at a second pressure being higher than the first pressure.

Alternatively, there is provided a method of direct reduction of a metal oxide material holding a first thermal energy into a reduced metal material by means of a metal material production configuration; wherein the metal oxide material, holding the first thermal energy, is provided by a metal oxide material provider unit.

Alternatively, the method comprises the steps of; charging the metal oxide material holding the first thermal energy into a direct reduction facility via a metal oxide material charging inlet device.

Alternatively, the reduction facility comprises an upper interior portion, a lower interior portion and an intermediate interior portion situated between the upper and lower interior portion.

Alternatively, there is provided a step of introducing a pre-heated hydrogen containing reducing agent, holding a second thermal energy, into the direct reduction facility via a reducing agent inlet device.

Alternatively, the reduction facility is configured for allowing direct reduction of the metal oxide material in the upper interior portion by using the first thermal energy of the metal oxide material to further heat the introduced pre-heated hydrogen containing reducing agent for providing a chemical reaction between the hydrogen of the introduced pre-heated hydrogen containing reducing agent and the metal oxide material.

Alternatively, the direct reduction facility is configured to allow the reduced metal material, and/or metal oxide material subject to direct reduction, to descend to the lower interior portion comprising a heat treatment zone.

Alternatively, the direct reduction facility is configured to allow the pre-heated hydrogen gas containing reducing agent to ascend upward in the direct reduction facility for contacting the descending metal oxide material.

Alternatively, the heat treatment zone is configured for exposing the reduced metal material, and/or metal oxide material subjected to direct reduction, to a pre-determined heat treatment temperature for obtaining said reduced metal material comprising reduced iron ore particles bond to each other forming heat treated and/or heat hardened and/or densified reduced metal material.

Alternatively, the heat treatment zone is configured for upholding the pre-determined heat treatment temperature by said introduction of the pre-heated hydrogen containing reducing agent.

Alternatively, the method comprises the step of discharging the reduced metal material that has been subjected to heat treatment.

Alternatively, the first thermal energy is used in the upper interior portion to further heat a remaining quantity of hydrogen of the pre-heated hydrogen containing reducing agent (as well as the formed water steam), which remaining quantity of hydrogen not yet being consumed and which has ascended upward in the direct reduction facility toward the upper interior portion.

Alternatively, the remaining quantity of hydrogen provides the chemical reaction and efficient direct reduction of the metal oxide material in the upper interior portion.

This is achieved despite the fact that the pre-heated hydrogen containing reducing agent will contain also the larger quantity of water steam and less quantity of hydrogen, the higher up the pre-heated hydrogen containing reducing agent has ascended in the direct reduction facility.

Alternatively, the first thermal energy is used in the upper interior portion to further heat a part of the pre-heated hydrogen containing reducing agent for providing said chemical reaction between the hydrogen of the pre-heated hydrogen containing reducing agent and the oxygen of the metal oxide material.

Alternatively, the first thermal energy is used in the upper interior portion to further heat a remaining quantity of hydrogen of the pre-heated hydrogen containing reducing agent (as well as the formed water steam), which remaining quantity of hydrogen of the hydrogen containing reducing agent not yet being consumed and which has ascended upward in the direct reduction facility toward an uppermost portion (direct reduction facility top interior) of the upper interior portion.

Alternatively, the remaining quantity of hydrogen provides the chemical reaction and efficient direct reduction of the metal oxide material (iron ore oxide material) in said uppermost portion, despite the fact that the pre-heated hydrogen containing reducing agent will contain also the larger quantity of water steam and less quantity of hydrogen, the higher up the pre-heated hydrogen containing reducing agent has ascended in the direct reduction facility.

Alternatively, the first thermal energy is thus used in the uppermost portion to further heat said remaining quantity of hydrogen for providing said chemical reaction between at least a portion of said remaining quantity of hydrogen and the oxygen of the metal oxide material (iron ore oxide material), achieving reduction wherein removal of oxygen from the iron ore oxide material is provided.

Alternatively, the excess pre-heated hydrogen containing reducing agent in the uppermost portion constitutes a top gas comprising hot water steam, which is withdrawn from the direct reduction facility via the top gas removing device.

Alternatively, the first thermal energy is thus used to further heat the remaining quantity of hydrogen for efficient direct reduction in the uppermost portion and/or to avoid undesirable/unwanted cooling down said remaining quantity of hydrogen of the hydrogen containing reducing agent not yet being consumed in the uppermost portion, for providing effective direct reduction.

It is thus avoided that the iron ore oxide material charged into the direct reduction facility cools down the remaining quantity of hydrogen of the hydrogen containing reducing agent in the uppermost portion.

Alternatively, the first thermal energy of the iron ore oxide material is used in the upper interior portion UP and/or an uppermost portion to further heat a remaining quantity of hydrogen of the pre-heated hydrogen containing reducing agent and/or water steam.

Alternatively, the top gas comprises the water steam generated by the chemical reaction between oxygen of the iron oxide material and hydrogen of the hydrogen containing reducing agent.

Alternatively, the top gas contains up to about 100 vol. % high-temperature water steam.

Alternatively, the top gas contains up to about 80-100 vol. %, preferably about 85-95 vol. %, high-temperature water steam.

Alternatively, the top gas contains up to about 60-90 vol. %, preferably about 70-80 vol. %, high-temperature water steam.

Alternatively, the top gas contains up to about 30-60 vol. %, preferably about 40-50 vol. %, high-temperature water steam.

Alternatively, the top gas contains up to about 10-40 vol. %, preferably about 20-30 vol. %, high-temperature water steam.

Alternatively, the top gas contains up to about 0-20 vol. %, preferably about 5-15 vol. %, high-temperature water steam.

Alternatively, the top gas contains up to about 0-15 vol. %, preferably about 1-10 vol. %, high-temperature water steam.

Alternatively, there is provided a method of direct reduction of iron ore oxide material holding a first thermal energy into a densified reduced iron material by means of the sponge iron production configuration ; wherein the iron ore oxide material, holding the first thermal energy, is provided by an iron ore oxide material provider unit, such as a iron ore oxide pelletizing apparatus and/or iron ore oxide pre-heating device.

Alternatively, the temperature of the iron ore oxide material holding the first thermal energy is achieved by means of the iron ore oxide material provider unit, configured to produce and/or pre-heat the iron ore oxide material holding the first thermal energy or substantially the first thermal energy.

Alternatively, the iron ore oxide material provider unit is electrically coupled to the control circuitry adapted to control the first thermal energy of the iron ore oxide material to be charged into the direct reduction facility.

Alternatively, the temperature of the iron ore oxide material, holding the first thermal energy provided by the iron ore oxide material provider unit, corresponds with a pre-determined temperature determined for avoiding “sticking” (avoiding adherence of iron ore oxide material particles to each other) in the upper interior portion of the direct reduction facility.

Such “sticking” would inhibit any subsequent direct reduction of the iron ore oxide material in an upper interior portion UP of the direct reduction facility.

Alternatively, the pre-determined temperature of the iron ore oxide material significant for avoiding “sticking” is controlled by a control circuitry to normally be at about 800° C. to about 1000° C., preferably about 875° C. to about 925° C.

Alternatively, the control circuitry is adapted to adjust the first thermal energy of the iron ore oxide material toward said pre-determined temperature for avoiding “sticking”.

It can be essential to avoid “sticking” of iron ore oxide material particles and/or pellets during charging and during direct reduction, since such “sticking” would lead to discontinuous operation of the direct reduction facility. Avoidance of “sticking” or lowering the sticking index SI can be achieved by avoiding very high temperatures (above 1200° C.) in the upper interior portion of the direct reduction facility.

Alternatively, the pre-determined temperature of the iron ore oxide material may be adjusted by the control circuitry based on specific properties of the direct reduction and/or from specific properties regarding the iron ore oxide material to be charged into the direct reduction facility and/or specific process parameters of the iron ore oxide pelletizing apparatus and/or the iron ore oxide pre-heating device, which specific properties and/or specific process parameters may be:
external shape of iron ore oxide pellets and/or
porosity and/or density of the iron ore oxide material and/or
mineralogy of the iron ore material and/or
composition of the iron ore oxide material and/or
agglomeration grade and/or
iron oxide material pellet size of the iron ore oxide material and/or
direct reduction rate of the iron ore oxide material and/or
hydrogen content of the hydrogen containing reducing agent and/or
desired temperature of the top gas and/or
output temperature of iron ore oxide material provided by the iron ore oxide pelletizing apparatus and/or the iron ore oxide pre-heating device;
taking into account the temperature of the first thermal energy, the composition of the pre-heated hydrogen containing reducing agent and the degree of direct reduction at a specific level in the direct reduction facility to achieve efficient heat treatment and obtaining a densified reduced iron ore material and/or semi-molten reduced iron ore material and/or passivated reduced iron ore material.

Alternatively, the pre-determined temperature of the iron ore oxide material is adjusted by the control circuitry based on residence time period, within which residence time period the iron ore oxide material is subjected to direct reduction and/or being exposed to the hydrogen containing reducing agent in the direct reducing facility.

Alternatively, the residence time period is defined as a time period during which the iron ore oxide material is subjected to direct reduction and heat treatment to complete the direct reduction process regarding the direct reduction of wüstite FeOₓ into iron Fe forming the densified reduced iron ore material and/or semi-molten reduced iron ore material and/or passivated reduced iron ore material.

Alternatively, the residence time period in the direct reduction facility is determined by the Hight-to-Width ratio of the interior of the direct reduction facility.

Alternatively, the residence time period in the direct reduction facility equals approximately 0.5-5.0 hours, preferably 1-4 hours.

Alternatively, the residence time period in the direct reduction facility equals approximately 2-6 hours, preferably 3-4 hours.

Alternatively, the residence time period in the direct reduction facility equals approximately 0.25-1.5 hours, preferably 0.5-1.25 hours.

Alternatively, the temperature and/or the mass flow of the hydrogen containing reducing agent may be adjusted by the control circuitry based on;
specific process parameters of the direct reduction and/or
specific properties of the iron ore oxide material, which specific properties and/or specific process parameters may be:
external shape of iron ore oxide pellets and/or
porosity and/or density of the iron ore oxide material and/or
mineralogy of the iron ore material and/or
composition of the iron ore oxide material and/or
agglomeration grade and/or
iron oxide material pellet size of the iron ore oxide material and/or
direct reduction rate of the iron ore oxide material and/or
hydrogen content of the hydrogen containing reducing agent and/or
desired temperature of the top gas and/or
output temperature of iron ore oxide material provided by the iron ore oxide pelletizing apparatus and/or the iron ore oxide pre-heating device;
taking into account the temperature of the first thermal energy, the composition of the pre-heated hydrogen containing reducing agent and the degree of direct reduction at a specific level in the direct reduction facility to achieve efficient heat treatment and obtaining a densified reduced iron ore material and/or semi-molten reduced iron ore material and/or passivated reduced iron ore material.

Alternatively, the control of the temperature (first thermal energy) of iron ore oxide material charged into the uppermost portion and the temperature (second thermal energy) of the hydrogen containing reducing agent introduced into the direct reduction facility is determined/controlled by the control circuitry based on the mass flow of charged iron ore oxide material and/or the mass flow of introduced hydrogen containing reducing agent.

Alternatively, the control of the mass flow of the hydrogen containing reducing agent introduced into the direct reduction facility is determined/controlled by the control circuitry based on the temperature (first thermal energy) of iron ore oxide material charged into the uppermost portion and/or the temperature (second thermal energy) of the hydrogen containing reducing agent introduced into the direct reduction facility to optimize the chemical reduction reaction and/or limit the high temperature water steam content in the direct reduction facility and/or to maintain required ratio between high temperature water steam and hydrogen to achieve an efficient chemical reduction reaction.

Alternatively, the method comprises the steps of; charging the iron ore oxide material holding the first thermal energy into an upper interior portion of the direct reduction facility via a metal oxide material charging inlet device.

Alternatively, the direct reduction facility comprises the upper interior portion, a lower interior portion and an intermediate interior portion situated between the upper and lower interior portion.

Alternatively, there is provided a step of introducing a pre-heated hydrogen containing reducing agent, holding a second thermal energy, into the direct reduction facility via a reducing agent inlet device.

Alternatively, the direct reduction facilityis configured for allowing direct reduction of the iron ore oxide material in the upper interior portion by using the first thermal energy of the iron ore oxide material to further heat the introduced pre-heated hydrogen containing reducing agent for providing a chemical reaction between the hydrogen of the introduced pre-heated hydrogen containing reducing agent and the iron ore oxide material.

Alternatively, the direct reduction facility is configured to allow the reduced iron material, and/or iron ore oxide material subject to direct reduction, to descend to the lower interior portion comprising a heat treatment zone.

Alternatively, the direct reduction facility is configured to allow the pre-heated hydrogen gas containing reducing agent to ascend upward in the direct reduction facility for contacting the descending iron ore oxide material.

Alternatively, the heat treatment zone is configured for exposing the reduced iron material, and/or iron ore oxide material subject to direct reduction, to a pre-determined heat treatment temperature for obtaining said reduced iron ore material comprising reduced iron ore particles bond to each other forming heat treated and/or heat hardened and/or densified reduced iron ore material.

Alternatively, the heat treatment zone is configured for upholding the pre-determined heat treatment temperature by said introduction of the pre-heated hydrogen containing reducing agent.

Alternatively, the method comprises the step of discharging the reduced iron material that has been subjected to heat treatment in the heat treatment zone.

The pre-heated hydrogen containing reducing agent comprises about 80-100% hydrogen, preferably up to 100% hydrogen by volume.

Alternatively, the hydrogen gas containing reducing agent that is fed into the direct reduction facility may exhibit a temperature of about 350° C. to about 900° C., preferably about 450° C. to about 750° C.

Alternatively, the hydrogen containing reducing agent being introduced into the direct reduction facility exhibits a temperature of about 500° C. to about 900° C., preferably about 600° C. to about 800° C.

Alternatively, the hydrogen containing reducing agent being introduced into the direct reduction facility exhibits a temperature of about 600° C. to about 1000° C., preferably about 700° C. to about 900° C.

Alternatively, the hydrogen containing reducing agent being introduced into the direct reduction facility exhibits a temperature of about 700° C. to about 1000° C., preferably about 850° C. to about 950° C.

Alternatively, the hydrogen containing reducing agent being introduced into the direct reduction facility exhibits a temperature of about 700° C. to about 1200° C., preferably about 800° C. to about 1100° C.

Alternatively, the hydrogen containing reducing agent is introduced into the upper interior portion and/or the lower interior portion and/or the intermediate interior portion.

Alternatively, the iron ore oxide material holding thermal energy, and being charged into the direct reduction facility, exhibits a temperature of 200° C. to about 500° C., preferably about 300° C. to about 400° C.

Alternatively, the iron ore oxide material holding thermal energy, and being charged into the direct reduction facility, exhibits a temperature of 300° C. to about 600° C., preferably about 400° C. to about 500° C.

Alternatively, the iron ore oxide material holding thermal energy and being charged into the direct reduction facility exhibits a temperature of 400° C. to about 700° C., preferably about 500° C. to about 600° C.

Alternatively, the iron ore oxide material holding thermal energy and being charged into the direct reduction facility exhibits a temperature of 500° C. to about 800° C., preferably about 600° C. to about 700° C.

Alternatively, the iron ore oxide material holding thermal energy and being charged into the direct reduction facility exhibits a temperature of 600° C. to about 900° C., preferably about 700° C. to about 800° C.

Alternatively, the iron ore oxide material holding thermal energy and being charged into the direct reduction facility exhibits a temperature of 700° C. to about 1000° C., preferably about 800° C. to about 900° C.

Alternatively, the iron ore oxide material holding thermal energy and being charged into the direct reduction facility exhibits a temperature of 800° C. to about 1100° C., preferably about 900° C. to about 1000° C.

Alternatively, the iron ore oxide material holding thermal energy and being charged into the direct reduction facility exhibits a temperature of 900° C. to about 1200° C., preferably about 1000° C. to about 1100° C.

Alternatively, the iron ore oxide material holding thermal energy being charged into the direct reduction facility exhibits a temperature of 1000° C. to about 1300° C., preferably about 1100° C. to about 1200° C.

Alternatively, the chemical reaction comprises a substantially or completely endothermal chemical reaction.

Alternatively, the thermal energy to be consumed by the direct reduction in the upper interior portion comprises the first thermal energy and/or second thermal energy.

Alternatively, the thermal energy to be consumed by the direct reduction in the intermediate interior portion comprises the first and/or second thermal energy.

Alternatively, the thermal energy to be consumed by the direct reduction in the lower interior portion comprises the second thermal energy.

Alternatively, the heat treatment is defined as densification (passivation) of the iron ore oxide material subject to direct reduction and/or the reduced iron ore material.

Alternatively, the iron ore oxide material subject to direct reduction and/or the reduced iron material achieved by the heat treatment is controlled by a first control circuitry (not shown) and/or control circuitry, which being adapted to adjust the second thermal energy of the hydrogen containing reducing agent by means of a reducing agent thermal energy adjusting device (not shown) for controlling the required heat treatment temperature predetermined to achieve the desired quality of the produced sponge iron and/or the densified reduced metal material and/or semi-molten reduced metal material and/or passivated reduced metal material.

Alternatively, the heat treatment temperature is controlled to be within the range of 150-550° C., preferably 250-450° C.

Alternatively, the heat treatment temperature is controlled to be within the range of 200-600°C., preferably 300-500° C.

Alternatively, the heat treatment temperature is controlled to be within the range of 250-650° C., preferably 350-550° C.

Alternatively, the heat treatment temperature is controlled to be within the range of about 350° C. to about 900° C., preferably about 450° C. to about 750° C.

Alternatively, the heat treatment temperature is controlled to be within the range of about 500° C. to about 900° C., preferably about 600° C. to about 800° C.

Alternatively, the heat treatment temperature is controlled to be within the range of about 600° C. to about 1000° C., preferably about 700° C. to about 900° C.

Alternatively, the heat treatment temperature is controlled to be within the range of about 700° C. to about 1000° C., preferably about 850° C. to about 950° C.

Alternatively, the heat treatment temperature is controlled to be within the range of about 700° C. to about 1200° C., preferably about 800° C. to about 1100° C.

Alternatively, the said control of the heat treatment temperature is regulated by the control circuitry controlling the temperature of the hydrogen gas containing reducing agent H.

Alternatively, the temperature (first thermal energy) of iron ore oxide material charged into the uppermost portion is controlled to be within the range of 100-500° C., preferably 200-400°C., and the hydrogen containing reducing agent introduced into the direct reduction facility is controlled to exhibit a temperature (second thermal energy) within the range of 600-1100°C., preferably 700-1000° C.

Alternatively, the temperature (first thermal energy) of iron ore oxide material charged into the uppermost portion is controlled to be within the range of 200-600° C., preferably 300-500°C., and the hydrogen containing reducing agent introduced into the direct reduction facility is controlled to exhibit a temperature (second thermal energy) within the range of 700-1200°C., preferably 800-1100° C.

Alternatively, the temperature (first thermal energy) of iron ore oxide material charged into the uppermost portion is controlled to be within the range of 300-700° C., preferably 400-600°C., and the hydrogen containing reducing agent introduced into the direct reduction facility is controlled to exhibit a temperature (second thermal energy) within the range of 700-1100°C., preferably 750-950° C.

Alternatively, the temperature (first thermal energy) of iron ore oxide material charged into the uppermost portion is controlled to be within the range of 400-800° C., preferably 500-700°C., and the hydrogen containing reducing agent introduced into the direct reduction facility is controlled to exhibit a temperature (second thermal energy) within the range of 800-1300°C., preferably 900-1200° C.

Alternatively, the first thermal energy of the iron ore oxide material is used in the upper interior portion UP and/or an uppermost portion to further heat a remaining quantity of hydrogen of the pre-heated hydrogen containing reducing agent and/or water steam.

Alternatively, the top gas comprises the water steam generated by the chemical reaction between oxygen of the iron oxide material and hydrogen of the hydrogen containing reducing agent.

Alternatively, the remaining quantity of hydrogen of the hydrogen containing reducing agent may be defined as hydrogen containing reducing agent not yet being consumed in the direct reduction in the major part of the upper interior portion and which has ascended upward in the direct reduction facility to the uppermost portion (direct reduction facility top interior) of the upper interior portion.

Alternatively, the remaining quantity of hydrogen provides the chemical reaction and efficient direct reduction of the metal oxide material (iron ore oxide material) in said uppermost portion, despite the fact that the pre-heated hydrogen containing reducing agent will contain the larger quantity of water steam and less quantity of hydrogen, the higher up the pre-heated hydrogen containing reducing agent has ascended in the direct reduction facility.

Alternatively, the first thermal energy is thus used in the uppermost portion to further heat said remaining quantity of hydrogen for providing said chemical reaction between at least a portion of said remaining quantity of hydrogen and the oxygen of the metal oxide material (iron ore oxide material), providing the direct reduction wherein efficient removal of oxygen from the iron ore oxide material is achieved.

Alternatively, the excess pre-heated hydrogen containing reducing agent, comprising excess hydrogen gas and hot water steam, forms a top gas in the uppermost portion, which top gas is withdrawn from the direct reduction facility via the top gas removing device.

Alternatively, the first thermal energy is thus used to further heat the remaining quantity of hydrogen for efficient direct reduction in the uppermost portion and/or to prevent cooling down said remaining quantity of hydrogen of the hydrogen containing reducing agent not yet being consumed in the uppermost portion, for providing effective direct reduction.

It is thus prevented that any eventual low temperature/ambient temperature iron ore oxide material charged into the direct reduction facility (in case of charging non-heated iron ore oxide material) cools down the remaining quantity of hydrogen of the hydrogen containing reducing agent in the uppermost portion.

This has the effect that an energy effective production of passivated reduced iron material, such as sponge iron, is achieved at the same time as top gas thermalcomprising hot water steam is produced, which may be used in a high temperature electrolysis unit.

In such way is achieved a densifying process for producing a densified reduced iron material, which thereby is prevented from re-oxidation in turn enabling secure and cost-effective transportation of reduced iron material, such as sponge iron to the metal making industry.

In such way is provided a metal material production configuration configured for production of a reduced iron material (carbon free) that is resistant to re-oxidation for cost-effective and secure fire resistant transport of the reduced metal material to a metal making industry or other customers.

The expression “metal oxide material” may be replaced by the expression “iron ore oxide material”.

The expression “metal oxide material provider unit” may be replaced by the expression “iron ore oxide material provider unit”.

The expression “reduced metal material” may be replaced by the expression “reduced iron ore material”.

The expression “reduced iron ore material” may be replaced by the expression “reduced iron material”.

The expression “metal material production configuration” may be replaced by the expression “sponge iron production configuration”.

The expression “metal oxide material” may be replaced by the expression “sulphide converted zinc ore oxide material” and/or “sulphide converted lead ore oxide material”.

Before charging and direct reduction/heat treatment of the metal oxide material, the respective zinc ore sulphide and lead ore sulphide concentrates being converted to oxides and agglomerated.

The word “consume” may be replaced by “use” or “utilise”.

The present disclosure may not be restricted to the examples described above, but many possibilities to modifications, or combinations of the described examples thereof should be apparent to a person with ordinary skill in the art without departing from the basic idea as defined in the appended claims.

### BRIEF DESCRIPTION OF THE DRAWING

Hereinafter, the invention will be described with reference to examples and accompanying schematic drawings, wherein for the sake of clarity and understanding of the invention some details of no importance may be deleted from the drawings.

FIG. 1 illustrates a metal material production configuration adapted for reduction of metal oxide material according to a first example;

FIGS. 2a-2b illustrate a second example of applying different designs of the interior of a direct reduction facility for affecting the residence time period for direct reduction of the metal oxide material;

FIG. 3 illustrates a metal material production configuration adapted for reduction of metal oxide material according to a third example;

FIG. 4 illustrates a flow diagram provided by a metal material production configuration according to a fourth example;

FIG. 5 illustrates a metal material production configuration adapted for reduction of metal oxide material according to a fifth example;

FIG. 6a illustrates a phase diagram of iron phase domains as a function of oxidizing power of hydrogen gas and temperature;

FIG. 6b illustrates a hydrogen/hydrogen+iron Mol/mol phase diagram relative the temperature;

FIGS. 7a-7c illustrate exemplary agglomerate structure transferring phases related to the heat treatment of the reduced metal material;

FIGS. 8a-8c illustrate exemplary agglomerate structure transferring phases related to the heat treatment of the reduced metal material;

FIGS. 9a-9b illustrate a metal material production configuration adapted for reduction of a metal oxide material according to a sixth example;

FIG. 10 illustrates a flowchart showing an exemplary method of direct reduction of a metal oxide material into reduced a metal material;

FIG. 11 illustrates a flowchart showing an exemplary method of direct reduction of a metal oxide material into reduced a metal material; and

FIG. 12 illustrates a control circuitry of a metal material production configuration according to a further example; and

FIG. 13 illustrates a sponge iron production configuration for production of densified reduced iron material according to a further embodiment.

### DETAILED DESCRIPTION

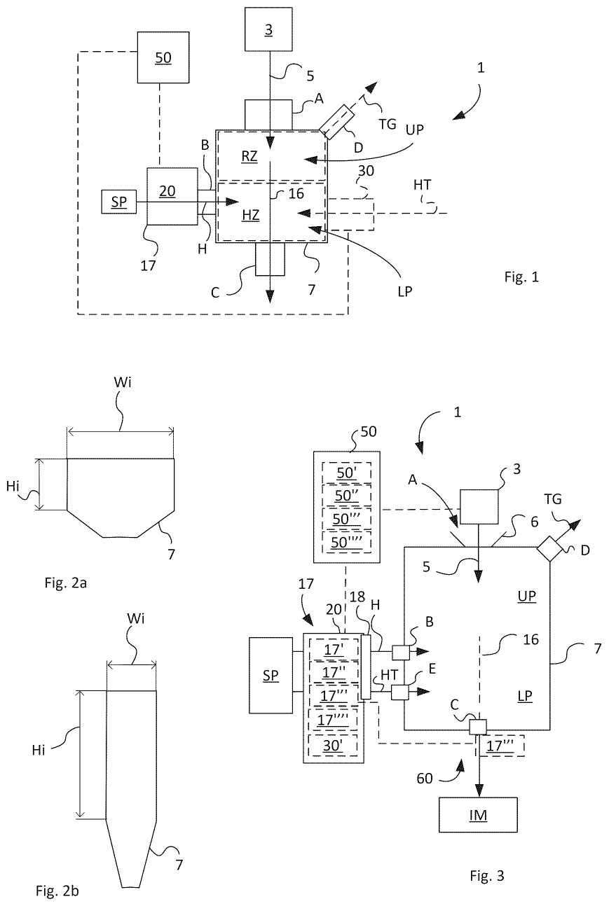

FIG. 1 illustrates a metal material production configuration 1 according to a first example provided for reduction of a metal oxide material into a reduced iron ore material 16 by means of a hydrogen containing reducing agent H. The metal material production configuration 1 is adapted for reduction of a metal oxide material 5 holding a first thermal energy. The metal material production configuration 1 comprises a metal oxide material provider unit 3, such as a metal oxide pelletizing plant (not shown) or metal oxide material pre-heating plant (not shown), configured for producing the metal oxide material holding a relatively high first thermal energy, such as a temperature of about 900° C. to about 1500° C., preferably about 1000° C. to about 1400° C.

The metal oxide material holding the first thermal energy is charged via a metal oxide material charging inlet device A into an upper interior portion UP of a direct reduction facility 7. The hydrogen containing reducing agent H is adapted to hold a second thermal energy, before being introduced into the direct reduction facility 7 via a reducing agent inlet device B.

A control circuitry 50 of the metal material production configuration 1 is electrically coupled to a heat treatment providing device 17 and is configured to operate the heat treatment providing device 17 to provide and/or to adjust the second thermal energy. The heat treatment providing device 17 may comprise an electric pre-heater (not shown) configured to pre-heat the hydrogen containing reducing agent H. The control circuitry 50 is adapted to control the heat treatment by adjusting the second thermal energy of the hydrogen containing reducing agent H by means of the heat treatment providing device 17. The heat treatment providing device 17 is configured to adjust the second thermal energy for upholding the required heat treatment temperature in the direct reduction facility 7 by the introduction of the pre-heated hydrogen containing reducing agent H holding the adjusted second thermal energy. The hydrogen containing reducing agent to be pre-heated is fed from a hydrogen containing reducing agent supply SP.

A direct reduction zone RZ of the direct reduction facility 7 is configured to reduce the metal oxide material 5 by using the first thermal energy of the metal oxide material 5 to heat or further heat the introduced hydrogen containing reducing agent H for providing the chemical reaction (e.g. substantially endothermal chemical reaction for the direct reduction) between the introduced hydrogen containing reducing agent H and the metal oxide material 5.

A heat treatment zone HZ of the direct reduction facility 7 is configured for heat treatment of the reduced metal material 16 by exposing the reduced metal material to the required heat treatment temperature for providing heat treatment of the reduced metal material to obtain the densified reduced metal material.

The schematically illustrated broken line boxes of the direct reduction zone RZ and the heat treatment zone HZ is just for illustration and may e.g. be overlapping broken line boxes or just one broken line box covering both the direct reduction zone RZ and the heat treatment zone HZ.

Alternatively, the hydrogen of the hydrogen containing reducing agent is produced by means of an electrolysis unit (not shown) configured to decompose water into hydrogen and oxygen.

The direct reduction facility may be designed as a solid-gas counter-current moving bed reactor, wherein the metal oxide material 5 holding the first thermal energy is charged into an upper interior portion UP of the direct reduction facility 7 via the metal oxide material charging inlet device A and descends by gravity toward a lower interior portion LP of the direct reduction facility 7.

The pre-heated hydrogen containing reducing agent H, holding the second thermal energy, is introduced into the lower interior portion LP and/or into the upper interior portion UP.

The metal material production configuration 1 further comprises a reducing agent pre-heating device 20 of the heat treatment providing device 17, which reducing agent pre-heating device 20 is adapted to pre-heat the hydrogen containing reducing agent H to be introduced into the direct reduction facility 7.

The control circuitry 50 is electrically coupled to and is adapted to control the reducing agent pre-heating device 20 for providing a second thermal energy of the hydrogen containing reducing agent for achieving the required reaction temperature for the direct reduction of the metal oxide material 5.

The control circuitry 50 furthermore is electrically coupled to and is adapted to control a first heat treatment agent feeding device 30, of the heat treatment providing device 17, to generate the heat treatment of the reduced metal material.

The metal material production configuration 1 is configured for reducing the metal oxide material 5 into the reduced metal material 16 by using the first thermal energy of the metal oxide material 5, that is charged into the direct reduction facility 7, to heat or further heat the introduced hydrogen containing reducing agent H holding the second thermal energy for providing a chemical reaction between the introduced hydrogen containing reducing agent H and the metal oxide material 5.

The high temperature of the metal oxide material 5 charged into the direct reduction facility 7, and the added thermal heat of the pre-heated hydrogen containing reducing agent, would result in an energy efficient reduction of the metal oxide material into the reduced metal material at the required reaction temperature and at the same time decreasing the cooling rate of the reduced metal material by means of the second thermal energy for exposing the reduced metal material to a required heat treatment temperature for providing the heat treatment of the reduced metal material to obtain a densified reduced metal material, whereas the required heat treatment temperature by the introduction of the pre-heated hydrogen containing reducing agent H can be upheld by means of the heat treatment providing device 17 and added thermal heat of the pre-heated hydrogen containing reducing agent.

Alternatively, the required reaction temperature for maintaining the direct reduction in the direct reduction facility may be at temperatures of from about 800° C. to about 1200° C., preferably about 900° C. to about 1100° C.

The hydrogen containing reducing agent H that continuously is fed into the direct reduction facility 7 may exhibit a temperature of about 350° C. to about 900° C., preferably about 450° C. to about 750° C.

Preferably, the heat treatment is achieved subsequently the reduction of the metal oxide material 5 into the reduced metal material 16, and before the reduced metal material 16 is discharged from the direct reduction facility 7.

The heat treatment provides densifying of the reduced metal material and/or the metal oxide material subject to reduction and produces a compact and dense reduced metal material resistant to re-oxidation.

The compact and dense reduced metal material is discharged via a metal material outlet C of a bottom section of the direct reduction facility 7, wherein the discharged reduced metal material in further transportation and storage would be resistant to re-oxidation and being fireproof.

The direct reduction facility 7 further comprises a top gas removing device D configured to remove a top gas TG from the direct reduction facility 7.

FIGS. 2a-2b illustrate a second example of using different designs of the interior of a direct reduction facility for affecting the residence time period for direct reduction of the metal oxide material. FIG. 2a shows a Hight-to-Width ratio Hi/Wi of the interior of an exemplary direct reduction facility 7 that is about 1:2. Such relatively low Hight-to-Width ratio Hi/Wi of the direct reduction facility 7 may require a relatively high required heat treatment temperature for the heat treatment due to the fact that the residence time period for maintaining the reduced metal material under heat treatment may be relatively short.

The step of upholding the required heat treatment temperature is thus provided to such extent that the introduction of the pre-heated hydrogen both provides the direct reduction of the metal oxide material and decreases the cooling rate of the reduced metal material descending through the direct reduction facility 7 for exposing the reduced metal material to the required heat treatment temperature for providing said heat treatment of the reduced metal material to obtain a densified and reduced metal material.

FIG. 2b shows a Hight-to-Width ratio Hi/Wi of the interior of an exemplary direct reduction facility 7 that is about 3:1. Such relatively elongated direct reduction facility 7 having a narrow width relative its hight may be regarded as suitable in case it is desirable to provide higher velocity of the reduced metal material that may have a tendency to “sticking”, still achieving the reduced metal material is exposed to the required heat treatment temperature for providing said heat treatment of the reduced metal material to obtain a densified and reduced metal material.

Alternatively, the Hight-to-Width ratio is greater than at least 1:1 up to 10:1 for achieving a residence time period suitable for said heat treatment of the reduced metal material at the same time as the flow of metal oxide material subject to reduction and/or the flow of reduced metal material through the interior of the direct reduction facility can be held high enough to avoid sticking of metal particles of the reduced metal material in the direct reduction facility, still exposing the reduced metal material to the required heat treatment temperature for providing said heat treatment of the reduced metal material to obtain a densified and reduced metal material.

FIG. 3 illustrates a metal material production configuration 1 according to a third example adapted for direct reduction of a metal oxide material 5 holding a first thermal energy to a reduced metal material 16. The direct reduction facility 7 is configured to provide heat treatment of the metal oxide material 5 subject to reduction and/or the reduced metal material 16 within a direct reduction facility 7.

The metal material production configuration 1 comprises a metal oxide material provider unit 3, such as a metal oxide material pelletizing plant (not shown) or a metal oxide material pre-heating plant (not shown), configured for providing the metal oxide material 5 holding the first thermal energy.

Alternatively, the metal oxide material holding the first thermal energy discharged from the metal oxide material provider unit exhibits a temperature of 1000° C. to about 1450° C., preferably about 1100° C. to about 1300° C., for the production of the metal oxide material holding the first thermal energy.

The metal material production configuration 1 further comprises a direct reduction facility 7 configured to reduce the metal oxide material 5 into the reduced metal material 16. A charging hopper arrangement 6 of a metal oxide material charging inlet device A is configured to charge the metal oxide material 5 into an upper interior portion UP of the reduction facility 7.

A hydrogen containing reducing agent H, holding a second thermal energy, is introduced into the direct reduction facility 7 via a reducing agent inlet device b. The hydrogen containing reducing agent H is adapted to react with the metal oxide material 5 holding the first thermal energy for reducing the metal oxide material 5 by utilizing the first thermal energy of the metal oxide material 5 to heat or further heat the introduced hydrogen containing reducing agent H for providing a chemical reaction (substantially a direct reduction) between the hydrogen containing reducing agent H and the metal oxide material 5. The hydrogen containing reducing agent H, holding a second thermal energy, is introduced into the direct reduction facility 7 via a reducing agent inlet device b.

The hydrogen of the hydrogen containing reducing agent H may be produced by an electrolysis unit (not shown). A reducing agent temperature regulator 18 of a heat treatment providing device 17 is configured to adjust (pre-heat and/or cool down) the second thermal energy of the hydrogen containing reducing agent H.

The hydrogen containing reducing agent to be pre-heated is fed from a hydrogen containing reducing agent supply SP.

The heat treatment involves densifying of the reduced metal material and provides a compact and dense reduced metal material (intermediate product IM) resistant to re-oxidation.

The compact and dense reduced metal material is discharged via a metal material discharge device C comprising a metal material outlet (not shown) of a bottom section 60 of the direct reduction facility 7. The intermediate product IM may be transported to a metal making industry (not shown) for the production of metal, such as steel.

The metal material production configuration 1 comprises a control circuitry 50, electrically coupled to the reducing agent temperature regulator 18 of the heat treatment providing device 17 configured for regulating the second thermal energy of the hydrogen containing reducing agent H before being introduced into the direct reduction facility 7.

The control circuitry 50 is adapted to operate the reducing agent temperature regulator 18 to cause the second thermal energy of the hydrogen containing reducing agent H for providing the required reaction temperature for said direct reduction and/or for providing said required heat treatment temperature.

The control circuitry 50 is adapted for controlling and monitoring the second thermal energy of the pre-heated hydrogen containing reducing agent H to be introduced into the direct reduction facility 7 by means of the heat treatment providing device 17.

Alternatively, the control circuitry 50 is electrically coupled to the metal oxide material provider unit 3 and is adapted to control and monitor the first thermal energy of the metal oxide material 5 to be charged into the upper interior portion UP.

The heat treatment providing device 17 comprises a reducing agent thermal energy adjusting device 17′, a reducing agent mass flow adjusting device 17″, a residence time period adjusting device 17′″, a pressurization adjusting device 17″″, and a heat treatment agent feeding device 30.

The heat treatment agent feeding device 30 is electrically coupled to the control circuitry 50 and is configured to operate the heat treatment agent feeding device 30 to introduce a pre-heated hydrogen containing heat treatment agent HT holding a third thermal energy into the direct reduction facility for exposing the reduced metal material to the required heat treatment temperature for upholding the required heat treatment temperature for providing the heat treatment of the reduced metal material 16 in the direct reduction facility to obtain the densified reduced metal material.

The hydrogen containing heat treatment agent to be pre-heated is fed from a hydrogen containing reducing agent supply SP to the heat treatment agent feeding device 30.

The pre-heated hydrogen containing heat treatment agent HT is introduced into the direct reduction facility 7 via a heat treatment agent inlet device 30 of the direct reduction facility 7.

The pre-heated hydrogen containing reducing agent H is introduced at a position that is below the metal oxide material charging inlet device A. The heat treatment agent feeding device 30 comprises a heat treatment agent pre-heating unit (not shown) configured to pre-heat the hydrogen containing heat treatment agent HT to reach the third thermal energy before being introduced into the direct reduction facility.

The reducing agent inlet device B is positioned at a level above the heat treatment agent inlet device 30.

The control circuitry 50 is electrically coupled to the heat treatment providing device 17 configured to provide the hydrogen containing heat treatment agent HT holding a third thermal energy adapted for said heat treatment.

The reducing agent thermal energy adjusting device 17′ configured to adjust the second thermal energy and is electrically coupled to a first control circuitry 50′, which is configured to control the reducing agent thermal energy adjusting device 17′ to introduce the heat treatment agent HT at a specific temperature for reaching the required heat treatment temperature.

The reducing agent thermal energy adjusting device may comprise an electric pre-heater configured to pre-heat the hydrogen containing reducing agent.

The reducing agent mass flow adjusting device 17″ is configured to adjust the mass flow of the hydrogen containing reducing agent H introduced into the direct reduction facility 7 and is electrically coupled to a second control circuitry 50″, which is configured to operate the reducing agent mass flow adjusting device 17″ to adjust the mass flow of the hydrogen containing reducing agent H for reaching the required heat treatment temperature.

The residence time period adjusting device 17′″ is configured to adjust a residence time period for keeping the reduced metal material 16 in the direct reduction facility 7 and is electrically coupled to a third control circuitry 50″′, which is configured to operate the residence time period adjusting device 17″′ for achieving said specific residence time period upholding the reduced metal material in the direct reduction facility 7 and for controlling the required heat treatment temperature.

The pressurization adjusting device (17″″) is configured to adjust pressurization of the interior of the direct reduction facility 7 and is electrically coupled to a fourth control circuitry 50″″, which is configured to operate the pressurization adjusting device 17″″ toward a specific pressure in the direct reduction facility 7 for controlling the required heat treatment temperature.

The direct reduction facility 7 further comprises a top gas outlet of the top gas removing device D configured to remove a top gas from the direct reduction facility 7, which preferably is re-used and/or re-circulated.

Alternatively, the top gas contains up to about 100 vol. % high-temperature water steam.

Alternatively, the top gas contains up to about 80-100 vol. %, preferably about 85-95 vol. %, high-temperature water steam.

Alternatively, the top gas contains up to about 60-90 vol. %, preferably about 70-80 vol. %, high-temperature water steam.

Alternatively, the top gas contains up to about 30-60 vol. %, preferably about 40-50 vol. %, high-temperature water steam.

Alternatively, the top gas contains up to about 10-40 vol. %, preferably about 20-30 vol. %, high-temperature water steam.

Alternatively, the top gas contains up to about 0-20 vol. %, preferably about 5-15 vol. %, high-temperature water steam.

Alternatively, the top gas contains up to about 0-15 vol. %, preferably about 1-10 vol. %, high-temperature water steam.

The reduction facility 7 is configured for permitting the reduced metal material 16 to descend downward in the direct reduction facility 7 for providing the heat treatment of the reduced metal material 16.

The chemical reactivity and/or high impetus of the pre-heated hydrogen containing reducing agent H is undestroyed after being introduced into the direct reduction facility 7 since the desired reaction temperature is reached by means of the first thermal energy of the charged metal oxide material. There is thus no need to “burn” the reducing agent for reaching the desired reaction temperature, e.g. by means of a fired heater.

The heat treatment agent feeding device 30 is electrically coupled to the control circuitry 50 and is configured to operate the heat treatment agent feeding device 30 to introduce a pre-heated hydrogen

Alternatively, the heat treatment of the reduced metal material 16 is achieved by the introduction of the pre-heated hydrogen containing heat treatment agent HT into the direct reduction facility 7, wherein the third thermal energy is increased by means of the heat treatment agent feeding device 30 in order to decrease the rate of cooling down the reduced metal material 16 in the direct reduction facility 7.

Alternatively, the control circuitry is electrically coupled to a heat treatment agent thermal energy adjusting device of the heat treatment agent feeding device 30 to adjust the third thermal energy of the hydrogen containing heat treatment agent HT for controlling the heat treatment of the reduced metal material 16.

The metal oxide material 5 that has been reduced into a reduced metal material and/or the metal oxide material 5 not yet fully reduced is exposed to a required heat treatment temperature for providing the heat treatment of the reduced metal material 16 to obtain a densified reduced metal material (e.g. a produced intermediate product or sponge iron restricted to re-oxidization), which has been discharged via the metal material discharge device C configured to discharge the reduced and heat treated metal material 16.

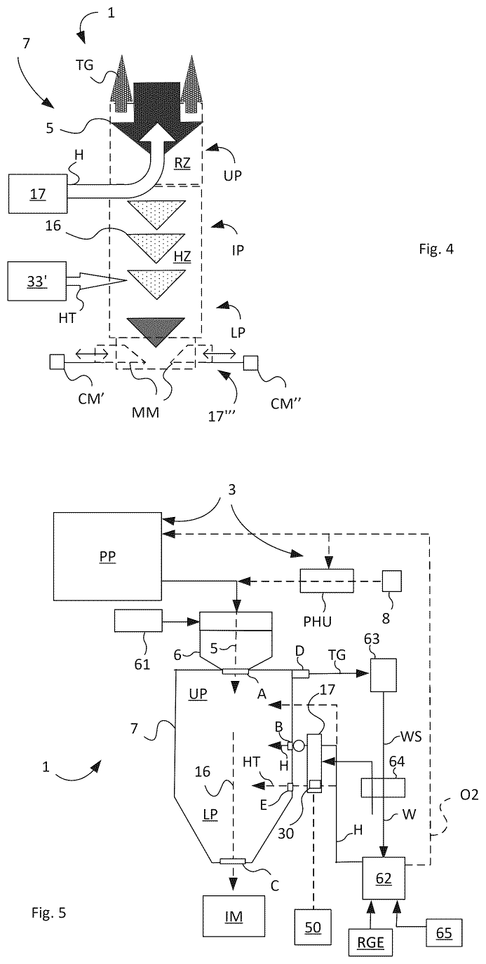

FIG. 4 illustrates a flow diagram provided by a metal material production configuration 1 according to a fourth example. A metal oxide material 5 holding thermal energy is charged into a reduction facility 7. The reduction facility 7 may be defined to have an upper interior portion UP, an intermediate interior portion IP and a lower interior portion LP. A hydrogen containing reducing agent H is introduced into the intermediate interior portion IP and flows upward meeting the downwardly transferred metal oxide material 5 holding thermal energy, whereby the upper interior portion UP functions as a counter current heat exchange zone for providing a chemical reaction (direct reduction) between the metal oxide material and the hydrogen containing reducing agent 6 generating a reduced metal material 16.

The hydrogen containing reducing agent H is pre-heated by means of a heat treatment providing device 17 for providing the hydrogen containing reducing agent H holding a second thermal energy.

Alternatively, the metal oxide material 5 holding the first thermal energy is moved from the upper interior portion UP downward to the intermediate interior portion IP and/or the lower interior portion LP by means of gravity.

A control circuitry (not shown) is electrically coupled to the heat treatment providing device 17 and is adapted to operate the heat treatment providing device 17 to pre-heat the hydrogen containing agent to hold the second thermal energy for exposing the reduced metal material 16 to a required heat treatment temperature for providing heat treatment of the reduced metal material to obtain a densified reduced metal material, and for upholding the required heat treatment temperature by the introduction of the pre-heated hydrogen containing reducing agent H.

Alternatively, the temperature of the hydrogen containing reducing agent H introduced into the intermediate interior portion IP is controlled by the control circuitry to provide the direct direction generating a top gas TG generated by the direct reduction and contains high-temperature water steam or substantially.

Alternatively, the temperature of the hydrogen containing reducing agent H introduced into the intermediate interior portion LP is controlled by the control circuitry to provide that the top gas TG comprises more than about 80-90% hot-temperature water steam.

The removed top gas TG also may comprise a residual volume of hydrogen that has not been consumed by the direct reduction.

In such way is achieved that complete reduction of the metal oxide material.

Due to the high temperature of the charged metal oxide material 5, there is achieved an efficient reduction of the metal oxide material 5 despite the fact that the hydrogen containing reducing agent H comprises a large amount of water in an upper section of the upper interior portion UP.

The metal material production configuration 1 is adapted to introduce a pre-heated hydrogen containing heat treatment agent HT holding a third thermal energy into the direct reduction facility 7 by means of a heat treatment agent feeding device 30 for exposing the reduced metal material 16 to the required heat treatment temperature for upholding the required heat treatment temperature and for providing said heat treatment of the reduced metal material 16 to obtain the densified reduced metal material.

The introduction of the pre-heated hydrogen containing heat treatment agent HT holding a third thermal energy is preferably provided into the intermediate interior portion IP and/or the lower interior portion LP. The temperature of the pre-heated hydrogen containing heat treatment agent HT holding a third thermal energy is controlled by the heat treatment agent feeding device 30 electrically coupled to the control circuitry for adaptation of said temperature toward the required heat treatment temperature providing the heat treatment.

In FIG. 4 is also shown a residence time period adjusting device 17″′ configured to adjust a residence time period for keeping the reduced metal material 16 in the direct reduction facility 7 during a specific residence time period. The residence time period adjusting device 17′″ is electrically coupled to the control circuitry, which is configured to operate the residence time period adjusting device 17′″ for achieving said specific residence time period for upholding the required heat treatment temperature of the reduced metal material in the direct reduction facility 7 and for controlling the required heat treatment temperature.

The residence time period adjusting device 17″′ comprises a choking mechanism CM′, CM″ adapted to regulate the discharge of the heat treated and reduced metal material from the lower interior portion LP. The choking mechanism CM′, CM″ is coupled to metal material flow reducing members MM. The operation of the choking mechanism CM′, CM″ is synchronized with the operation of a charging arrangement (not shown) configured to adjust the amount of the metal oxide material 5 into the reduction facility 7.

Alternatively, the heat treatment agent feeding device 30 is configured to adjust the third thermal energy for controlling the heat treatment to produce a semi-molten and/or densified reduced metal material.

FIG. 5 illustrates a metal material production configuration 1 adapted for direct reduction of metal oxide material 5 into a reduced iron ore material 16 and heat treatment of the reduced iron ore material by means of a hydrogen containing reducing agent H according to a fifth example. The metal material production configuration 1 comprises a direct reduction facility 7 arranged to be able to be charged with the metal oxide material 5 holding a first thermal energy, which first thermal energy is provided by means of a metal oxide material provider unit 3, such as a metal oxide pelletizing plant PP and/or a metal oxide material pre-heating unit PHU configure to pre-heat metal oxide material transferred from a metal oxide material storage 8.

The metal oxide material to be charged into the direct reduction facility may hold a temperature of about 900° C. to about 1500° C., preferably about 1000° C. to about 1400° C.

The metal oxide material holding the first thermal energy is charged via a metal oxide material charging inlet device A into an upper interior portion UP of a direct reduction facility 7. The hydrogen containing reducing agent H holds a second thermal energy before being introduced into the direct reduction facility 7 via a reducing agent inlet device B.

Alternatively, a reducing agent inlet E of a reducing agent inlet device 30 configured to introduce a pre-heated hydrogen containing reducing agent HT into the direct reduction facility 7 may be positioned lower than a reducing agent inlet device B configured to introduce the pre-heated hydrogen containing reducing agent H.

A charging hopper arrangement 6 of the metal oxide material charging inlet device A is configured to charge the metal oxide material 5 into an upper interior portion UP of the reduction facility 7. The metal oxide material substantially holding the second thermal energy is transferred from the metal oxide material provider unit 3 the direct reduction facility 7 via the charging hopper arrangement 6.

The metal material production configuration 1 comprises a first seal gas introduction device 61 configured to introduce a seal gas into the direct reduction facility 7 in conjunction with the step of charging the metal oxide material holding the first thermal energy into the direct reduction facility 7. The material production configuration 1 comprises a second seal gas introduction device (not shown) configured to introduce a second seal gas into the direct reduction facility 7 via a metal material discharge device C configured to discharge the reduced metal material 16 that has been subjected to heat treatment.

In such way is achieved that the charging of the metal oxide material into the direct reduction facility can be made safely without any formations of explosive air/process gas mixtures when the charging proceeds.

This is achieved by ensuring that only the seal gas, and not air, is introduced into the direct reduction facility when charging the metal oxide material, wherein no process gas and/or hydrogen containing reducing gas escapes the direct reduction facility during the charging of the metal oxide material.

A control circuitry 50 of the metal material production configuration 1 is electrically coupled to a heat treatment providing device 17 and is configured to operate the heat treatment providing device 17 to provide and/or to adjust the second thermal energy of the pre-heated hydrogen containing reducing agent H. The heat treatment providing device 17 may comprise an electric pre-heater (not shown) configured to pre-heat the hydrogen containing reducing agent H.

The control circuitry 50 is adapted to control heat treatment of the reduced metal material 16 by adjusting the second thermal energy of the hydrogen containing reducing agent H by means of the heat treatment providing device 17. The heat treatment providing device 17 is configured to adjust the second thermal energy for upholding the required heat treatment temperature in the direct reduction facility 7 by the introduction of the pre-heated hydrogen containing reducing agent H holding the adjusted second thermal energy. The hydrogen containing reducing agent to be pre-heated is fed from a hydrogen containing reducing agent supply SP, such as an electrolysis unit 62. The electrolysis unit 62 is configured to decompose water W into hydrogen, to be comprised in the hydrogen containing reducing agent H, and into oxygen gas O2. The oxygen gas O2 produced by the electrolysis unit 62 may be transferred into an oxidation zone (not shown) of the metal oxide pelletizing plant PP for oxidation of the pre-heated metal ore material.

The direct reduction facility 7 is configured to reduce the metal oxide material 5 by using the first thermal energy of the metal oxide material 5 to heat or further heat the introduced hydrogen containing reducing agent H for providing the chemical reaction (e.g. substantially endothermal chemical reaction for the direct reduction) between the introduced hydrogen containing reducing agent H and the metal oxide material 5.

The direct reduction facility 7 is configured for said heat treatment of the reduced metal material 16 by exposing the reduced metal material 16 to the required heat treatment temperature for providing heat treatment of the reduced metal material 16 to obtain the densified reduced metal material restricted to re-oxidation.

The direct reduction facility may be designed as a solid-gas counter-current moving bed reactor, wherein the metal oxide material 5 holding the first thermal energy is charged into an upper interior portion UP of the direct reduction facility 7 via the metal oxide material charging inlet device A and descends by gravity toward a lower interior portion LP of the direct reduction facility 7.

The pre-heated hydrogen containing reducing agent H, holding the second thermal energy, is introduced into the lower interior portion LP and/or into the upper interior portion UP and may be introduced into the direct reduction facility 7 at levels above each other.

The control circuitry 50 furthermore is electrically coupled to and is adapted to control a heat treatment agent feeding device 30, of the heat treatment providing device 17, to provide the heat treatment of the reduced metal material 16. The heat treatment agent feeding device 30 is adapted to introduce and adjust a third thermal energy of a pre-heated hydrogen containing heat treatment agent HT to be introduced into the direct reduction facility 7, for exposing the reduced metal material to a required heat treatment temperature for providing the heat treatment of the reduced metal material to obtain a densified reduced metal material, and in turn an intermediate product restricted to re-oxidate.

The high temperature of the metal oxide material 5 charged into the direct reduction facility 7, and the added thermal heat of the pre-heated hydrogen containing reducing agent holding the second thermal energy, and the added pre-heated hydrogen containing heat treatment agent HT, being controlled by the control circuitry for achieving an energy efficient reduction of the metal oxide material into the reduced metal material at the required reaction temperature and at the same time decreasing the cooling rate of the reduced metal material by means of the second and third thermal energy for exposing the reduced metal material to the required heat treatment temperature for providing the heat treatment of the reduced metal material to obtain a densified reduced metal material.

The required heat treatment temperature is controlled by the control circuitry by adjusting the third thermal energy for upholding the required heat treatment temperature, and for providing said heat treatment of the reduced metal material 16 to obtain the densified reduced metal material, and is controlled by the control circuitry to adjust the second thermal energy of the pre-heated hydrogen containing reducing agent H by means of the heat treatment providing device 17.

The direct reduction facility 7 comprises a top gas outlet device D configured to remove a top gas TG comprising excess hydrogen and a high-temperature water steam from the direct reduction facility 7. The high-temperature water steam being generated by the chemical reaction between the metal oxide material and hydrogen of the hydrogen containing reducing agent. The top gas TG is fed to a filter unit 63 adapted to separate the high-temperature from the excess hydrogen gas to be recycled (not shown) back to the hydrogen containing reducing agent H. The filer unit 63 furthermore is configured to filter the high-temperature water steam WS from impurities. The high-temperature water steam WS is fed to a heat exchange device 64 for providing the water W to be fed to the electrolysis unit 62. The heat exchange device 64 is adapted to cool down the high-temperature water steam WS into water W and transfer the recovered heat to e.g. the heat treatment providing device 17 for pre-heating the hydrogen containing reducing agent H and/or the hydrogen containing heat treatment agent HT. The electrolysis unit 62 configured to decompose the water W is electrically supplied by a re-generative energy supply RGE and may add water from an external water supply 65.

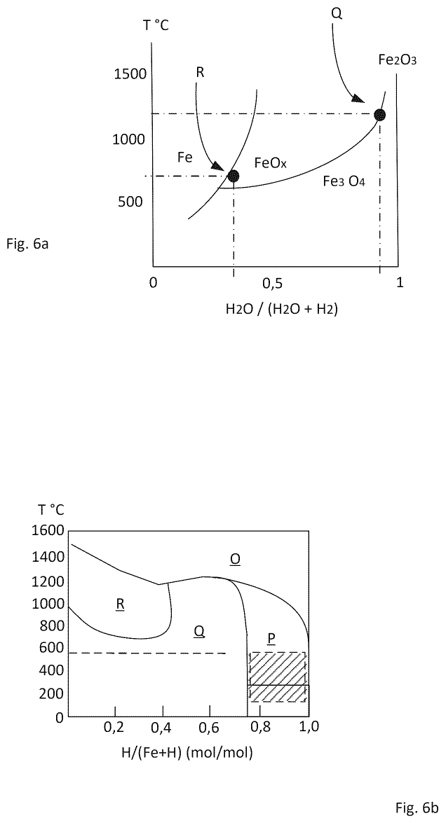

FIG. 6a illustrates a phase diagram of iron phase domains as a function of oxidizing power of hydrogen gas and temperature, for the gas mixture H₂—H₂O. As shown in the diagram, the reduction of the iron ore oxide material in the form of hematite and/or magnetite and/or wüstite into reduced iron ore material, takes place in two or three stages, depending on whether the temperature is above or below 570° C. In this case, hematite Fe₂O₃ is first reduced to magnetite Fe₃O₄, then to wüstite FeOₓ and finally to iron Fe. The diagram discloses that increasing content of water steam in the interior of the direct reduction facility requires higher temperature to obtain reduction of the iron ore oxide material.

The pre-heated hydrogen gas containing reducing agent, holding the second thermal energy, being introduced into the direct reduction facility ascends upward in the direct reduction facility and contacts the descending iron ore oxide material holding the first thermal energy.

Due to the charging of the iron ore oxide material holding the first thermal energy into the direct reduction facility it is possible to achieve reduction of the iron ore oxide material even if the content of water in the hydrogen containing reducing agent is high (see phase diagram in FIG. 6a at position Q, e.g. H2O/(H2O+H2) quota about 0.9).

Preferably, further down in the direct reduction facility there is less water steam in the reduction facility since the hydrogen to less extent has been used for the reduction, whereby the hydrogen content may be twice as much as the water content (see phase diagram in FIG. 5 at position R, e.g. a H2O/(H2O+H2) quota about 0.3).

Alternatively, a control circuitry (not shown) is adapted to control the direct reduction in the direct reduction facility such that the reduced metal material is not re-oxidated.

Alternatively, the control circuitry may by electrically coupled to a reducing agent thermal energy adjusting device (not shown) and/or to a pressurization adjusting device (not shown) and/or to a reducing agent mass flow adjusting device (not shown) and/or to a means of a residence time period adjusting device (not shown) adapted to hold the iron oxide material during a specific residence time period in the direct reduction facility and/or to a reducing agent introduction/pressurizing device and/or a top gas removing device, for controlling the required reaction temperature and/or the required heat treatment temperature.

The required reaction temperature is thus maintained by means of the control circuitry by adjusting the temperature of the hydrogen containing reducing agent and/or by adjusting the mass flow of the pre-heated hydrogen containing reducing agent fed into the direct reduction facility.

In such way, it is achieved that the reduced iron material not being re-oxidized in the direct reduction facility.

Alternatively, the control circuitry is adapted to control the reducing agent mass flow adjusting device to feed a relatively high flow of the pre-heated hydrogen containing reducing agent into the direct reduction facility to hold down the water steam burden in the direct reduction facility for providing an efficient direct reduction and fully direct reduced iron material.

By means of the second thermal energy of the pre-heated hydrogen containing reducing agent it is thus possible to provide the direct reduction despite the fact that the content of water is relatively high further down in the direct reduction facility (see phase diagram in FIG. 5 at position R).

Alternatively, the pre-heated hydrogen gas containing reducing agent introduced into the direct reduction facility may exhibit higher thermal heat the further up the pre-heated hydrogen gas containing reducing agent ascends in the direct reduction facility, since the warmer iron ore oxide material heats or further heats the pre-heated hydrogen gas containing reducing agent for providing the required reaction temperature.

Alternatively, the pre-heated hydrogen gas containing reducing agent reduces the cooling rate of the iron ore oxide material descending in the direct reduction facility.

Alternatively, the pre-heated hydrogen gas containing reducing agent contains an increased amount of high-temperature water-steam the farther up the pre-heated hydrogen gas containing reducing agent ascends in the direct reduction facility. However, it is possibly to reach efficient direct reduction of the iron ore oxide material (see phase diagram in FIG. 5 at position Q).

As shown in the diagram, hematite is to be reduced into magnetite at high temperature (e.g. 1200° C.), despite that the water content (position Q) of the pre-heated hydrogen gas containing reducing agent is high, direct reduction into magnetite still can be achieved.

In such a way, the heat energy of the first thermal energy generated by the metal oxide material provider unit in combination with the heat energy of the hydrogen gas containing reducing agent 8 and/or the hydrogen gas H being utilized to reach the required reaction temperature.

In such way, it is achieved that the high temperature of the iron ore oxide material promotes an efficient direct reduction, despite the fact that the pre-heated hydrogen gas containing reducing agent will contain a high content of water-steam (see phase diagram in FIG. 5 at position Q).

Alternatively, any excess hydrogen gas being separated from the top gas removed from the direct reduction facility being re-circulated to the direct reduction facility and introduced into the direct reduction facility.

In such way, a cost-effective use of hydrogen gas is achieved.

The pre-heated hydrogen containing reducing agent, holding the second thermal energy, introduced into the reduction facility thus ascends through the upper interior portion and contacts the descending iron ore oxide material, holding the first thermal energy, under reduction, whereas the pre-heated hydrogen containing reducing agent will contain increased amount of water the farther up the introduced pre-heated hydrogen containing reducing agent ascends in the direct reduction facility.

As shown in the diagram, hematite is to be reduced into magnetite at high temperature (e.g. 1200° C.), despite the fact that the water content of the pre-heated hydrogen containing reducing agent H is high, reduction into magnetite still can be achieved.

The present disclosure makes use of the high temperature of the iron ore oxide material holding the first thermal energy, which iron ore oxide material is charged from the iron ore oxide material provider unit into the upper interior portion UP. This high temperature of the iron ore oxide material promotes that reduction is possible, despite the fact that the pre-heated hydrogen containing reducing agent, when reaching an upper section of the upper interior portion UP, will contain an increased amount of water.

The required heat treatment temperature is upheld to such extent that the introduction of the pre-heated hydrogen containing reducing agent H, holding the second energy, decreases the cooling rate of the reduced iron material descending through the direct reduction facility (see reference 7 in e.g. FIG. 5).

It is thus is achieved that the cooling rate of the reduced iron material descending through the direct reduction facility is decreased enabling an effective heat treatment of the reduced metal material, by which is achieved exposing the reduced metal material to a required heat treatment temperature for providing heat treatment of the reduced iron material to obtain a densified reduced iron material and upholding the required heat treatment temperature by the introduction of the pre-heated hydrogen containing reducing agent H by means of a heat treatment providing device (not shown).

FIG. 6b illustrates a hydrogen/hydrogen+iron Mol/mol phase diagram relative the temperature and in view of from different temperature aspects. Reference O represents the Liquidus phase, reference P represents the Bcc/Liquidus phase, reference Q represents the Bcc phase, and reference R represents the Fcc phase. It is shown in the diagram that the iron Fe will be subject to sintering in the Bcc+Liquidus phase P, i.e. the iron of the reduced iron ore material hardens by means of a relative low temperature (e.g. 200-600° C.) due to the fact that the introduced hydrogen maintains its chemical reactivity and/or high impetus. This will in turn promote, in combination with the expose of the reduced iron material to the required heat treatment temperature for providing heat treatment of the reduced iron material, the production of a densified reduced metal material.

Furthermore the reducing agent does not need to be “burned” or strongly heated up to e.g. 1200° C. for providing thermal energy for providing the direct reduction as being shown by prior art.

On the contrary, by using the first thermal energy of the iron ore oxide material charged into the reduction facility for providing heat to the direct reduction, it now is possibly further down in the direct reduction facility, by controlling the second thermal energy of the introduced hydrogen containing reducing agent, to decrease the cooling rate of the reduced iron material when it descends through the direct reduction facility.

The heat treatment can thus efficiently be achieved by the second thermal energy and by the maintained high chemical reactivity and/or high impetus of the hydrogen containing reducing agent.

Alternatively, the heat treatment of the reduced iron material is achieved at a required heat-treatment temperature under an extended time period for achieving the densified reduced iron material, wherein to great extent the wüstite is reduced into sponge iron and/or densified surface of the produced sponge iron agglomerate.

In such way is achieved that the intermediate product (such as sponge iron) is prevented from having a tendency to revert back to an oxide state when exposed to natural atmosphere.

In such way the risk for spontaneous ignition of the sponge iron is eliminated.

In such way is achieved safe transport of sponge iron to a steel making industry.

In such way the steel making industry saves energy in the production of steel by using the sponge iron in an electric arc furnace.

Alternatively, the control circuitry 50 is adapted for controlling the heat treatment providing device to provide the heat treatment of the reduced iron material in the Bcc+Liquidus phase P, or preferably exposing the reduced iron ore material. By exposing the reduced iron material and/or the iron ore oxide material under reduction, and by upholding the required heat treatment temperature, under an extended time period, and by using the hydrogen containing reducing agent with high chemical reactivity and/or high impetus, there is provided a reduced iron material that is resistant to re-oxidation.

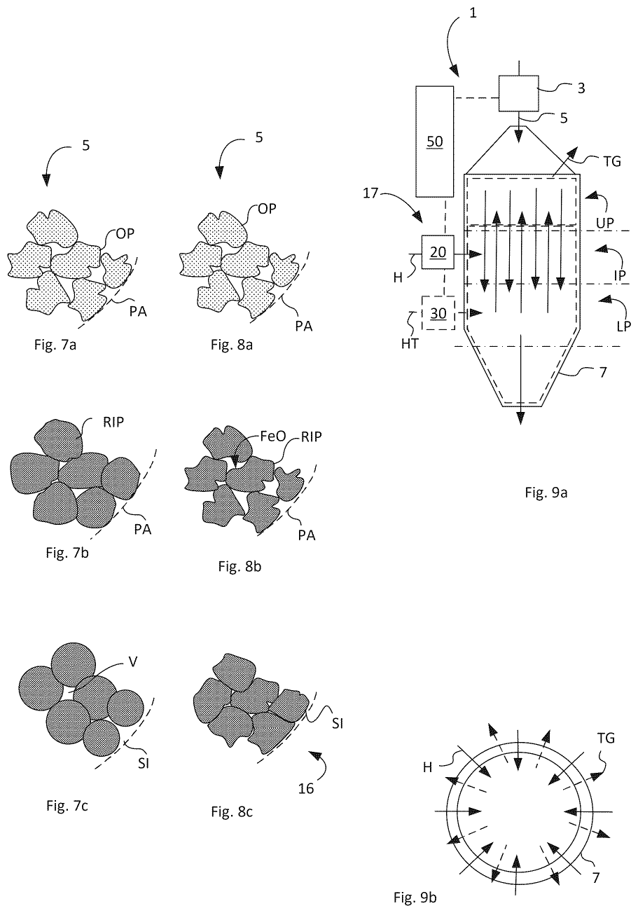

FIGS. 7a-7c illustrate agglomerate structure transferring phases related to the heat treatment herein disclosed. FIG. 7a shows an agglomerate structure of an iron ore oxide material 5 holding a first thermal energy, which iron ore oxide material 5 being subject to direct reduction in an upper interior portion of a reduction facility (not shown).

A porous agglomerate PA comprising iron ore oxide particles OP being charged into the direct reduction facility. The iron ore oxide particles are bond to each other forming a porous agglomerate PA, the porosity of which promotes a chemical reaction between the iron ore oxide and the introduced pre-heated hydrogen containing reducing agent for initially providing the direct reduction. FIG. 7b shows the porous agglomerate PA comprising reduced iron material ready for heat treatment. Eventually, some content of wüstite material may exist in spaces between the reduced iron particles RIP wherein the high content of hydrogen of the introduced hydrogen containing gas and the required heat treatment temperature provides that eventual FeO compound being decomposed into Fe and oxygen by that the oxygen and hydrogen combine and form water molecules.

Alternatively, for providing a reduced iron material that is resistant to re-oxidation, the reduced iron material and/or the iron ore oxide material (primarily the wüstite material) is exposed to a required heat treatment temperature for providing said heat treatment to obtain a densified reduced iron material as shown in FIG. 7c. This is achieved by upholding the required heat treatment temperature by the introduction of the pre-heated hydrogen containing reducing agent by means of a heat treatment providing device and/or by the introduction of the pre-heated hydrogen containing heat treatment agent for providing said heat treatment of the reduced iron material and/or the iron ore oxide material subject to reduction.

Alternatively, spheroidization of the reduced iron particles is provided by said heat treatment.

Alternatively, the produced sponge iron SI shown in FIG. 7c comprises voids V. The heat treatment generates the sponge iron SI to be resistant to re-oxidation.

FIG. 7c shows a portion of a sponge iron SI that is densified by means of said heat treatment.

FIGS. 8a-8c illustrate agglomerate structure transferring phases related to the heat treatment herein disclosed. FIG. 8a shows an agglomerate structure of an iron ore oxide material 5 holding a first thermal energy, which iron ore oxide material 5 being subject to direct reduction in an upper interior portion of a reduction facility (not shown).

A porous agglomerate PA comprising iron ore oxide particles OP being charged into the direct reduction facility. The iron ore oxide particles are bond to each other forming a porous agglomerate PA, the porosity of which promotes a chemical reaction between the iron ore oxide and the introduced pre-heated hydrogen containing reducing agent for initially providing the direct reduction. FIG. 8b shows the porous agglomerate PA comprising reduced iron material ready for heat treatment. Eventually, some content of wüstite material may exist in spaces between the reduced iron particles RIP wherein the high content of hydrogen of the introduced hydrogen containing gas and the required heat treatment temperature provides that eventual FeO compound being decomposed into Fe and oxygen by that the oxygen and hydrogen combine and form water molecules.

Alternatively, for providing a reduced iron material that is resistant to re-oxidation, the reduced iron material and/or the iron ore oxide material (primarily the wüstite material) is exposed to a required heat treatment temperature for providing said heat treatment to obtain a densified reduced iron material as shown in FIG. 8c. This is achieved by upholding the required heat treatment temperature by the introduction of the pre-heated hydrogen containing reducing agent by means of a heat treatment providing device and/or by the introduction of the pre-heated hydrogen containing heat treatment agent for providing said heat treatment of the reduced iron material and/or the iron ore oxide material subject to reduction. FIG. 8c schematically shows a portion of a sponge iron SI that is densified by means of said heat treatment.

FIGS. 9a-9b illustrate a metal material production configuration 1 adapted for reduction of an iron ore oxide material 5 holding a first thermal energy, which material is charged into a reduced iron ore material 16 according to a sixth example.

The metal material production configuration 1 comprises an iron ore oxide material provider unit 3, such as an iron ore oxide pelletizing plant or iron ore oxide pre-heating plant, configured for providing the iron ore oxide material 5 holding the first thermal energy.

The metal material production configuration 1 comprises a reduction facility 7 configured to reduce the iron ore oxide material 5. The iron ore oxide material 5 holding the first thermal energy is charged into an upper interior portion UP of the reduction facility 7.

The metal material production configuration 1 comprises a reducing agent pre-heating device 20 of a heat treatment providing device 17, which reducing agent pre-heating device 20 and/or heat treatment providing device 17 being configured to operate the direct reduction facility 7 in order to reach a required heat treatment temperature.

The reducing agent pre-heating device 20 is configured to pre-heat a hydrogen containing reducing agent H introduced into the direct reduction facility 7 and is electrically coupled to a control circuitry 50 of the metal material production configuration 1.

A heat treatment agent feeding device 30 of the heat treatment providing device 17 is adapted to introduce and adjust a third thermal energy of a pre-heated hydrogen containing heat treatment agent HT to be introduced into the direct reduction facility 7, for exposing the reduced iron material to a required heat treatment temperature for providing the heat treatment of the reduced metal material to obtain a densified reduced metal material.

Additionally, the pre-heated hydrogen containing reducing agent H may be introduced at different levels into the reduction facility 7 and may be introduced at different temperatures, with different pressures, flows etc.

The direct reduction facility 7 may comprise an upper interior portion UP and/or an intermediate interior portion IP and/or a lower interior portion.

The introduced pre-heated hydrogen containing reducing agent H fed into the direct reduction facility may comprise about 80-100% hydrogen, preferably about 85-95% hydrogen, or pure hydrogen.

FIG. 9b shows the reduction facility 7 in cross-section. The pre-heated hydrogen containing reducing agent H and an optionally introduced pre-heated hydrogen containing heat treatment agent (not shown), being introduced circumferentially around the direct reduction facility 7. A top gas TG is discharged from the reduction facility 7 circumferentially. Alternatively, the required reaction temperature for maintaining the direct reduction in the direct reduction facility may be at temperatures of from about 800° C. to about 1200° C., preferably about 900° C. to about 1100° C.

The hydrogen containing reducing agent H that continuously is fed into the direct reduction facility 7 may exhibit a temperature of about 350° C. to about 900° C., preferably about 450° C. to about 750° C.

Preferably, the heat treatment is achieved subsequently the reduction of the iron ore oxide material 5 into the reduced iron material, and before the reduced iron material 16 is discharged from the direct reduction facility 7.

Alternatively, the heat treatment provides densifying of the reduced iron material and/or the iron ore oxide material subject to reduction and produces a compact and dense reduced metal material resistant to re-oxidation.

The compact and dense reduced iron material is discharged via a bottom outlet (not shown) of a bottom section (not shown) of the direct reduction facility 7. The discharged reduced iron material is resistant to re-oxidation and being fireproof for further transport in atmospheric air.

FIG. 10 illustrates a flowchart showing an exemplary method of direct reduction of a metal oxide material into reduced a metal material by means of a metal material production configuration (not shown), which metal material production configuration comprises a metal oxide material provider unit (not shown) configured to provide the metal oxide material holding the first thermal energy, and a direct reduction facility (not shown) comprising; a metal oxide material charging inlet device, a reducing agent inlet device configured to introduce a hydrogen containing reducing agent holding a second thermal energy, a direct reduction zone of the direct reduction facility configured to reduce the metal oxide material by using the first thermal energy of the metal oxide material to heat or further heat the introduced hydrogen containing reducing agent for providing a chemical reaction between the introduced hydrogen containing reducing agent and the metal oxide material, a heat treatment zone of the direct reduction facility configured for heat treatment of the reduced metal material by exposing the reduced metal material to a required heat treatment temperature for providing heat treatment of the reduced metal material to obtain a densified reduced metal material, a heat treatment providing device configured for upholding the required heat treatment temperature by the introduction of the pre-heated hydrogen containing reducing agent, and a metal material discharge device configured to discharge the reduced metal material that has been subjected to heat treatment.

The method in FIG. 10 starts at step 801. Step 802 comprises adaption of the method. Step 803 comprises stop of the method. Step 802 may comprise the steps of; charging the metal oxide material holding the first thermal energy into the direct reduction facility via the metal oxide material charging inlet device; introducing the pre-heated hydrogen containing reducing agent, holding the second thermal energy, into the direct reduction facility via the reducing agent inlet device; reducing the metal oxide material by using the first thermal energy of the metal oxide material to heat or further heat the introduced pre-heated hydrogen containing reducing agent for providing the chemical reaction between the introduced pre-heated hydrogen containing reducing agent and the metal oxide material; exposing the reduced metal material to the required heat treatment temperature for providing heat treatment of the reduced metal material to obtain a densified reduced metal material; upholding the required heat treatment temperature by the introduction of the pre-heated hydrogen containing reducing agent by means of the heat treatment providing device; and discharging the reduced metal material that has been subjected to heat treatment.

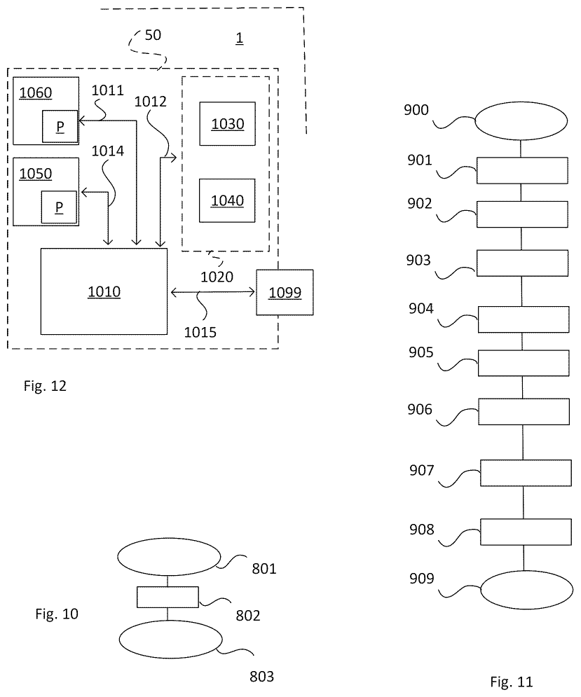

FIG. 11 illustrates a flowchart showing an exemplary method of direct reduction of a metal oxide material into reduced a metal material by means of a metal material production configuration herein disclosed. The method starts at step 900. Step 901 comprises charging the metal oxide material holding the first thermal energy into a direct reduction facility via a metal oxide material charging inlet device. Step 902 comprises introducing a pre-heated hydrogen containing reducing agent, holding a second thermal energy, into the direct reduction facility via a reducing agent inlet device. Step 903 comprises reducing the metal oxide material by using the first thermal energy of the metal oxide material to heat or further heat the introduced pre-heated hydrogen containing reducing agent for providing a chemical reaction between the introduced pre-heated hydrogen containing reducing agent and the metal oxide material. Step 904 comprises exposing the reduced metal material to a required heat treatment temperature for providing heat treatment of the reduced metal material to obtain a densified reduced metal material. Step 905 comprises upholding the required heat treatment temperature by the introduction of the pre-heated hydrogen containing reducing agent by means of a heat treatment providing device. Step 906 comprises discharging the reduced metal material that has been subjected to heat treatment. Step 907 comprises introducing a pre-heated hydrogen containing heat treatment agent holding a third thermal energy into the direct reduction facility by means of a heat treatment agent feeding device for exposing the reduced metal material to the required heat treatment temperature for upholding the required heat treatment temperature, and for providing said heat treatment of the reduced metal material to obtain the densified reduced metal material. Step 908 comprises providing the upholding of the required heat treatment temperature to such extent that the introduction of the pre-heated hydrogen containing reducing agent generates the direct reduction of the metal oxide material and decreases the cooling rate of the reduced metal material descending through the direct reduction facility for maintaining said required heat treatment temperature. Step 909 comprises stop of the method.

FIG. 12 illustrates a control circuitry 50 of a metal material production configuration 1 according to a further example. The control circuitry 50 is configured to control any exemplary method herein disclosed. The control circuitry 50 may comprise a non-volatile memory NVM 1020, which is a computer memory that can retain stored information even when the control circuitry 50 or the computer not being powered. The control circuitry 50 further comprises a processing unit 1010 and a read/write memory 1050.

The NVM 1020 comprises a first memory unit 1030. A computer program (which can be of any type suitable for any operational database) is stored in the first memory unit 1030 to be used for controlling the functionality of the control circuitry 50.

Furthermore, the control circuitry 50 comprises a bus controller (not shown), a serial communication port (not shown) providing a physical interface, through which information transfers separately in two directions.

The control circuitry 50 may comprise any suitable type of I/O module (not shown) providing input/output signal transfer, an A/D converter (not shown) for converting varying signals from temperature detectors of the direct reduction facility and the heat treatment providing device for detecting temperatures of the introduced pre-heated hydrogen containing reducing agent and/or the actual heat treatment temperature and/or the pre-heated hydrogen containing heat treatment agent) into binary code suitable to be processed by the computer of the control circuitry 50.

The control circuitry 50 may make use of different monitoring units (not shown) of the direct reduction facility to monitor the heat treatment temperature and/or the properties of the produced heat treated and reduced metal material resistant to re-oxidation.

The control circuitry 50 further comprises an input/output unit (not shown) for adaption to time and date. The control circuitry 50 also may comprise an event counter (not shown) for counting the number of event multiples that occur during the adjustment of the chemical reaction and/or the heat treatment for obtaining the densified reduced metal material.

Furthermore, the control circuitry 50 includes interrupt units (not shown) for providing a multi-tasking performance and real time computing. The NVM 1020 also includes a second memory unit 1040 for external controlled operation.

A data medium adapted for storing a data program P comprises driver routines adapted for commanding the operation of the metal material production configuration 1.

The data program P is adapted for operating the control circuitry 50 in performing any exemplary method described herein. The data program P comprises routines for executing commands under operation of the metal material production configuration 1. The data program P comprises a program code, which is readable on the computer, for causing the computer to perform an exemplary method herein described.

The data program P further may be stored in a separate memory 1060 and/or in the read/write memory 1050. The data program P may be stored in executable or compressed data format.

It is to be understood that when the processing unit 1010 is described to execute a specific function that involves that the processing unit 1010 executes a certain part of the program stored in the separate memory 1060 or a certain part of the program stored in the read/write memory 1050.

The processing unit 1010 is associated with a signal (data) port 1099, such as a serial bus, for communication via a first data bus 1015, which signal port 1099 may be adapted to be electrically coupled to an electronic control circuitry of an operator interface circuitry (not shown).

In such way is achieved that an operator via a display of the electronic control circuitry is able to control and monitor the metal material production configuration 1.

The non-volatile memory NVM 1020 is adapted for communication with the processing unit 1010 via a second data bus 1012. The separate memory 1060 is adapted for communication with the processing unit 1010 via a third data bus 1011. The read/write memory 1050 is adapted to communicate with the processing unit 1010 via a fourth data bus 1014. The signal port 1099 may be connectable to data links of e.g. a network coupled to the control circuitry 50.

Data that has been received by the signal port 1099 may be temporary stored in the second memory unit 1040. After that the received data is temporary stored, the processing unit 1010 will be ready to execute the program code, in accordance with the exemplary methods.

Preferably, the signals (received by the signal port 1099) comprise information about operational status of the metal material production configuration 1 and/or the direct reduction facility.

The received signals at the signal port 1099 may be used by the control circuitry 50 for controlling and monitoring the direct reduction and said heat treatment.

The received signals at the signal port 1099 may be used for historic data and data regarding operation of the metal material production configuration 1.

The metal material production configuration 1 may be configured to be coupled to a data network via the signal port 1099 configured for electrical interface explicitly providing electrical compatibility and related data transfer, which data may include information about status of the metal material production configuration 1 and the temperature detectors. Data may also be manually fed to the computer via any suitable communication device, such as a display (not shown).

Separate sequences of the method may be executed by the computer, wherein the computer runs the data program P being stored in the separate memory 1060 or in the read/write memory 1050. When the computer runs the data program P, the method steps according to any example disclosed herein will be executed.

A data program product comprising a program code stored on a data medium may be provided, which data program product is readable on the computer, for performing the exemplary method steps herein, when the data program P is run on the computer.

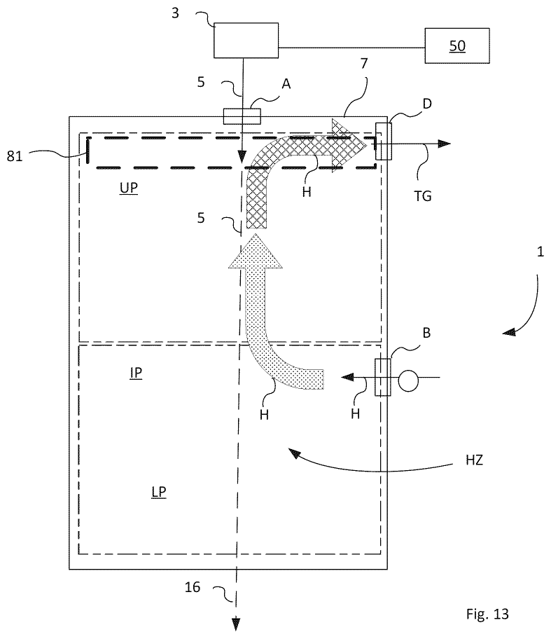

FIG. 13 illustrates a metal material production configuration 1, such as a sponge iron production configuration 1, according to a further embodiment.

Alternatively, there is provided a method of direct reduction of iron ore oxide material 5 holding a first thermal energy into a densified reduced iron material 16 by means of the sponge iron production configuration 1; wherein the iron ore oxide material 5, holding the first thermal energy, is provided by an iron ore oxide material provider unit 3, such as a iron ore oxide pelletizing apparatus and/or iron ore oxide pre-heating device.

Alternatively, the temperature of the iron ore oxide material holding the first thermal energy is achieved by means of the iron ore oxide material provider unit 3, configured to produce and/or pre-heat the iron ore oxide material 5 holding the first thermal energy or substantially the first thermal energy.

Alternatively, the iron ore oxide material provider unit 3 is electrically coupled to the control circuitry 50 adapted to control the first thermal energy of the iron ore oxide material 5 to be charged into the direct reduction facility 7.

Alternatively, the temperature of the iron ore oxide material 5, holding the first thermal energy provided by the iron ore oxide material provider unit 3, corresponds with a pre-determined temperature determined for avoiding “sticking” (avoiding adherence of iron ore oxide material particles to each other) in the upper interior portion of the direct reduction facility 7.

Such “sticking” would inhibit any subsequent direct reduction of the iron ore oxide material in an upper interior portion UP of the direct reduction facility 7.

Alternatively, the pre-determined temperature of the iron ore oxide material 5 significant for avoiding “sticking” is controlled by a control circuitry 50 to normally be at about 800° C. to about 1000° C., preferably about 875° C. to about 925° C.

Alternatively, the control circuitry 50 is adapted to adjust the first thermal energy of the iron ore oxide material toward said pre-determined temperature for avoiding “sticking”.

It can be essential to avoid “sticking” of iron ore oxide material particles and/or pellets during charging and during direct reduction, since such “sticking” would lead to discontinuous operation of the direct reduction facility 7. Avoidance of “sticking” or lowering the sticking index SI can be achieved by avoiding very high temperatures (above 1200° C.) in the upper interior portion of the direct reduction facility.

Alternatively, the pre-determined temperature of the iron ore oxide material 5 may be adjusted by the control circuitry 50 based on specific properties of the direct reduction and/or from specific properties regarding the iron ore oxide material to be charged into the direct reduction facility and/or specific process parameters of the iron ore oxide pelletizing apparatus and/or the iron ore oxide pre-heating device, which specific properties and/or specific process parameters may be:
external shape of iron ore oxide pellets and/or
porosity and/or density of the iron ore oxide material and/or
mineralogy of the iron ore material and/or
composition of the iron ore oxide material and/or
agglomeration grade and/or
iron oxide material pellet size of the iron ore oxide material and/or
direct reduction rate of the iron ore oxide material and/or
hydrogen content of the hydrogen containing reducing agent and/or
desired temperature of the top gas and/or
output temperature of iron ore oxide material provided by the iron ore oxide pelletizing apparatus and/or the iron ore oxide pre-heating device;
taking into account the temperature of the first thermal energy, the composition of the pre-heated hydrogen containing reducing agent and the degree of direct reduction at a specific level in the direct reduction facility to achieve efficient heat treatment and obtaining a densified reduced iron ore material and/or semi-molten reduced iron ore material and/or passivated reduced iron ore material.

Alternatively, the pre-determined temperature of the iron ore oxide material 5 is adjusted by the control circuitry 50 based on residence time period, within which residence time period the iron ore oxide material 5 is subjected to direct reduction and/or being exposed to the hydrogen containing reducing agent in the direct reducing facility.

Alternatively, the residence time period is defined as a time period during which the iron ore oxide material 5 is subjected to direct reduction and heat treatment to complete the direct reduction process regarding the direct reduction of wüstite FeOₓ into iron Fe forming the densified reduced iron ore material and/or semi-molten reduced iron ore material and/or passivated reduced iron ore material,

Alternatively, the residence time period in the direct reduction facility 7 is determined by the Hight-to-Width ratio of the interior of the direct reduction facility.

Alternatively, the residence time period in the direct reduction facility 7 equals approximately 0.5-5.0 hours, preferably 1-4 hours.

Alternatively, the residence time period in the direct reduction facility 7 equals approximately 2-6 hours, preferably 3-4 hours.

Alternatively, the residence time period in the direct reduction facility 7 equals approximately 0.25-1.5 hours, preferably 0.5-1.25 hours.

Alternatively, the temperature and/or the mass flow of the hydrogen containing reducing agent may be adjusted by the control circuitry 50 based on;
specific process parameters of the direct reduction and/or
specific properties of the iron ore oxide material, which specific properties and/or specific process parameters may be:
external shape of iron ore oxide pellets and/or
porosity and/or density of the iron ore oxide material and/or
mineralogy of the iron ore material and/or
composition of the iron ore oxide material and/or
agglomeration grade and/or
iron oxide material pellet size of the iron ore oxide material and/or
direct reduction rate of the iron ore oxide material and/or
hydrogen content of the hydrogen containing reducing agent and/or
desired temperature of the top gas and/or
output temperature of iron ore oxide material provided by the iron ore oxide pelletizing apparatus and/or the iron ore oxide pre-heating device;
taking into account the temperature of the first thermal energy, the composition of the pre-heated hydrogen containing reducing agent and the degree of direct reduction at a specific level in the direct reduction facility to achieve efficient heat treatment and obtaining a densified reduced iron ore material and/or semi-molten reduced iron ore material and/or passivated reduced iron ore material.

Alternatively, the control of the temperature (first thermal energy) of iron ore oxide material charged into the uppermost portion and the temperature (second thermal energy) of the hydrogen containing reducing agent introduced into the direct reduction facility is determined/controlled by the control circuitry based on the mass flow of charged iron ore oxide material and/or the mass flow of introduced hydrogen containing reducing agent.

Alternatively, the control of the mass flow of the hydrogen containing reducing agent introduced into the direct reduction facility is determined/controlled by the control circuitry based on the temperature (first thermal energy) of iron ore oxide material charged into the uppermost portion and/or the temperature (second thermal energy) of the hydrogen containing reducing agent introduced into the direct reduction facility to optimize the chemical reduction reaction and/or limit the high temperature water steam content in the direct reduction facility and/or to maintain required ratio between high temperature water steam and hydrogen to achieve an efficient chemical reduction reaction.

Alternatively, the method comprises the steps of; charging the iron ore oxide material 5 holding the first thermal energy into an upper interior portion UP of the direct reduction facility 7 via a metal oxide material charging inlet device A.

Alternatively, the direct reduction facility 7 comprises the upper interior portion UP, a lower interior portion LP and an intermediate interior portion IP situated between the upper and lower interior portion LP.

Alternatively, there is provided a step of introducing a pre-heated hydrogen containing reducing agent H, holding a second thermal energy, into the direct reduction facility 7 via a reducing agent inlet device B.

Alternatively, the direct reduction facility 7 is configured for allowing direct reduction of the iron ore oxide material 5 in the upper interior portion UP by using the first thermal energy of the iron ore oxide material 5 to further heat the introduced pre-heated hydrogen containing reducing agent H for providing a chemical reaction between the hydrogen of the introduced pre-heated hydrogen containing reducing agent H and the iron ore oxide material 5.

Alternatively, the direct reduction facility 7 is configured to allow the reduced iron material 16, and/or iron ore oxide material 5 subject to direct reduction, to descend to the lower interior portion LP comprising a heat treatment zone HZ.

Alternatively, the direct reduction facility 7 is configured to allow the pre-heated hydrogen gas containing reducing agent H to ascend upward in the direct reduction facility 7 for contacting the descending iron ore oxide material 5.

Alternatively, the heat treatment zone HZ is configured for exposing the reduced iron material 16, and/or iron ore oxide material 5 subject to direct reduction, to a pre-determined heat treatment temperature for obtaining said reduced iron ore material 16 comprising reduced iron ore particles bond to each other forming heat treated and/or heat hardened and/or densified reduced iron ore material 16.

Alternatively, the heat treatment zone HZ is configured for upholding the pre-determined heat treatment temperature by said introduction of the pre-heated hydrogen containing reducing agent.

Alternatively, the method comprises the step of discharging the reduced iron material 16 that has been subjected to heat treatment in the heat treatment zone.

The pre-heated hydrogen containing reducing agent H comprises about 80-100% hydrogen, preferably up to 100 % hydrogen by volume.

Alternatively, the hydrogen gas containing reducing agent H that is fed into the direct reduction facility 7 may exhibit a temperature of about 350° C. to about 900° C., preferably about 450° C. to about 750° C.

Alternatively, the hydrogen containing reducing agent H being introduced into the direct reduction facility 7 exhibits a temperature of about 500° C. to about 900° C., preferably about 600° C. to about 800° C.

Alternatively, the hydrogen containing reducing agent H being introduced into the direct reduction facility 7 exhibits a temperature of about 600° C. to about 1000° C., preferably about 700° C. to about 900° C.

Alternatively, the hydrogen containing reducing agent H being introduced into the direct reduction facility 7 exhibits a temperature of about 700° C. to about 1000° C., preferably about 850° C. to about 950° C.

Alternatively, the hydrogen containing reducing agent H being introduced into the direct reduction facility 7 exhibits a temperature of about 700° C. to about 1200° C., preferably about 800° C. to about 1100° C.

Alternatively, the hydrogen containing reducing agent H is introduced into the upper interior portion UP and/or the lower interior portion LP and/or the intermediate interior portion IP.

Alternatively, the iron ore oxide material 5 holding thermal energy, and being charged into the direct reduction facility 7, exhibits a temperature of 200° C. to about 500° C., preferably about 300° C. to about 400° C.

Alternatively, the iron ore oxide material 5 holding thermal energy, and being charged into the direct reduction facility 7, exhibits a temperature of 300° C. to about 600° C., preferably about 400° C. to about 500° C.

Alternatively, the iron ore oxide material 5 holding thermal energy and being charged into the direct reduction facility 7 exhibits a temperature of 400° C. to about 700° C., preferably about 500° C. to about 600° C.

Alternatively, the iron ore oxide material 5 holding thermal energy and being charged into the direct reduction facility 7 exhibits a temperature of 500° C. to about 800° C., preferably about 600° C. to about 700° C.

Alternatively, the iron ore oxide material 5 holding thermal energy and being charged into the direct reduction facility 7 exhibits a temperature of 600° C. to about 900° C., preferably about 700° C. to about 800° C.

Alternatively, the iron ore oxide material 5 holding thermal energy and being charged into the direct reduction facility 7 exhibits a temperature of 700° C. to about 1000° C., preferably about 800° C. to about 900° C.

Alternatively, the iron ore oxide material 5 holding thermal energy and being charged into the direct reduction 7 facility exhibits a temperature of 800° C. to about 1100° C., preferably about 900° C. to about 1000° C.

Alternatively, the iron ore oxide material 5 holding thermal energy and being charged into the direct reduction facility 7 exhibits a temperature of 900° C. to about 1200° C., preferably about 1000° C. to about 1100° C.

Alternatively, the iron ore oxide material 5 holding thermal energy being charged into the direct reduction facility 7 exhibits a temperature of 1000° C. to about 1300° C., preferably about 1100° C. to about 1200° C.

Alternatively, the chemical reaction comprises a substantially or completely endothermal chemical reaction.

Alternatively, the thermal energy to be consumed by the direct reduction in the upper interior portion UP comprises the first thermal energy and/or second thermal energy.

Alternatively, the thermal energy to be consumed by the direct reduction in the intermediate interior portion IP comprises the first and/or second thermal energy.

Alternatively, the thermal energy to be consumed by the direct reduction in the lower interior portion LP comprises the second thermal energy.

Alternatively, the heat treatment is defined as densification (passivation) of the iron ore oxide material subject to direct reduction and/or the reduced iron ore material.

Alternatively, the iron ore oxide material subject to direct reduction and/or the reduced iron material achieved by the heat treatment is controlled by a first control circuitry (not shown) and/or control circuitry, which being adapted to adjust the second thermal energy of the hydrogen containing reducing agent H by means of a reducing agent thermal energy adjusting device (not shown) for controlling the required heat treatment temperature predetermined to achieve the desired quality of the produced sponge iron and/or the densified reduced metal material and/or semi-molten reduced metal material and/or passivated reduced metal material.

Alternatively, the heat treatment temperature is controlled to be within the range of 150-550° C., preferably 250-450° C.

Alternatively, the heat treatment temperature is controlled to be within the range of 200-600°C., preferably 300-500° C.

Alternatively, the heat treatment temperature is controlled to be within the range of 250-650° C., preferably 350-550° C.

Alternatively, the heat treatment temperature is controlled to be within the range of about 350° C. to about 900° C., preferably about 450° C. to about 750° C.

Alternatively, the heat treatment temperature is controlled to be within the range of about 500° C. to about 900° C., preferably about 600° C. to about 800° C.

Alternatively, the heat treatment temperature is controlled to be within the range of about 600° C. to about 1000° C., preferably about 700° C. to about 900° C.

Alternatively, the heat treatment temperature is controlled to be within the range of about 700° C. to about 1000° C., preferably about 850° C. to about 950° C.

Alternatively, the heat treatment temperature is controlled to be within the range of about 700° C. to about 1200° C., preferably about 800° C. to about 1100° C.

Alternatively, the said control of the heat treatment temperature is regulated by the control circuitry controlling the temperature of the hydrogen gas containing reducing agent H.

Alternatively, the temperature (first thermal energy) of iron ore oxide material charged into the uppermost portion is controlled to be within the range of 100-500° C., preferably 200-400°C., and the hydrogen containing reducing agent introduced into the direct reduction facility is controlled to exhibit a temperature (second thermal energy) within the range of 600-1100°C., preferably 700-1000° C.

Alternatively, the temperature (first thermal energy) of iron ore oxide material charged into the uppermost portion is controlled to be within the range of 200-600° C., preferably 300-500°C., and the hydrogen containing reducing agent introduced into the direct reduction facility is controlled to exhibit a temperature (second thermal energy) within the range of 700-1200°C., preferably 800-1100° C.

Alternatively, the temperature (first thermal energy) of iron ore oxide material charged into the uppermost portion is controlled to be within the range of 300-700° C., preferably 400-600°C., and the hydrogen containing reducing agent introduced into the direct reduction facility is controlled to exhibit a temperature (second thermal energy) within the range of 700-1100°C., preferably 750-950° C.

Alternatively, the temperature (first thermal energy) of iron ore oxide material charged into the uppermost portion is controlled to be within the range of 400-800° C., preferably 500-700°C., and the hydrogen containing reducing agent introduced into the direct reduction facility is controlled to exhibit a temperature (second thermal energy) within the range of 800-1300°C., preferably 900-1200° C.

Alternatively, the first thermal energy of the iron ore oxide material 5 is used in the upper interior portion UP and/or an uppermost portion 81 to further heat a remaining quantity of hydrogen of the pre-heated hydrogen containing reducing agent and/or water steam.

Alternatively, the top gas comprises the water steam generated by the chemical reaction between oxygen of the iron oxide material and hydrogen of the hydrogen containing reducing agent.

Alternatively, the remaining quantity of hydrogen of the hydrogen containing reducing agent may be defined as hydrogen containing reducing agent not yet being consumed in the direct reduction in the major part of the upper interior portion and which has ascended upward in the direct reduction facility 7 to the uppermost portion 81 (direct reduction facility top interior) of the upper interior portion UP.

Alternatively, the remaining quantity of hydrogen provides the chemical reaction and efficient direct reduction of the metal oxide material (iron ore oxide material) in said uppermost portion 81, despite the fact that the pre-heated hydrogen containing reducing agent will contain the larger quantity of water steam and less quantity of hydrogen, the higher up the pre-heated hydrogen containing reducing agent has ascended in the direct reduction facility.

Alternatively, the first thermal energy is thus used in the uppermost portion 81 to further heat said remaining quantity of hydrogen for providing said chemical reaction between at least a portion of said remaining quantity of hydrogen and the oxygen of the metal oxide material (iron ore oxide material), providing the direct reduction wherein efficient removal of oxygen from the iron ore oxide material is achieved.

Alternatively, the excess pre-heated hydrogen containing reducing agent H, comprising excess hydrogen gas and hot water steam, forms a top gas TG in the uppermost portion 81, which top gas TG is withdrawn from the direct reduction facility 7 via the top gas removing device D.

Alternatively, the first thermal energy is thus used to further heat the remaining quantity of hydrogen for efficient direct reduction in the uppermost portion 81 and/or to prevent cooling down said remaining quantity of hydrogen of the hydrogen containing reducing agent not yet being consumed in the uppermost portion 81, for providing effective direct reduction.

It is thus prevented that any eventual low temperature/ambient temperature iron ore oxide material charged into the direct reduction facility 7 (in case of charging non-heated iron ore oxide material) cools down the remaining quantity of hydrogen of the hydrogen containing reducing agent in the uppermost portion 81.

This has the effect that an energy effective production of passivated reduced iron material, such as sponge iron, is achieved at the same time as top gas TG comprising hot water steam is produced, which may be used in a high temperature electrolysis unit.

In such way is achieved a densifying process for producing a densified reduced iron material, which thereby is prevented from re-oxidation in turn enabling secure and cost-effective transportation of reduced iron material, such as sponge iron to the metal making industry.

In such way is provided a metal material production configuration configured for production of a reduced iron material (carbon free) that is resistant to re-oxidation for cost-effective and secure fire resistant transport of the reduced metal material to a metal making industry or other customers.

The present disclosure may not be restricted to the examples described above, but many possibilities to modifications, or combinations of the described examples thereof should be apparent to a person with ordinary skill in the art without departing from the basic idea as defined in the appended claims.

1. A method of direct reduction of a metal oxide material holding a first thermal energy into a reduced metal material by a metal material production configuration, wherein the metal oxide material, holding the first thermal energy, is provided by a metal oxide material provider unit, the method comprising steps of:
charging the metal oxide material holding the first thermal energy into a direct reduction facility via a metal oxide material charging inlet device;
introducing a pre-heated hydrogen containing reducing agent, holding a second thermal energy, into the direct reduction facility via a reducing agent inlet device;
reducing the metal oxide material by using the first thermal energy of the metal oxide material to heat or further heat the introduced pre-heated hydrogen containing reducing agent for providing a chemical reaction between the introduced pre-heated hydrogen containing reducing agent and the metal oxide material;
exposing the reduced metal material to a required heat treatment temperature for providing heat treatment of the reduced metal material to obtain a densified reduced metal material;
upholding the required heat treatment temperature by introduction of the pre-heated hydrogen containing reducing agent by a heat treatment providing device; and
discharging the reduced metal material that has been subjected to heat treatment.

2. The method according to claim 1, wherein the method comprises the further step of:
introducing a pre-heated hydrogen containing heat treatment agent holding a third thermal energy into the direct reduction facility by a heat treatment agent feeding device for exposing the reduced metal material to the required heat treatment temperature for upholding the required heat treatment temperature, and for providing said heat treatment of the reduced metal material to obtain the densified reduced metal material.

3. The method according to claim 1, wherein the step of upholding the required heat treatment temperature is provided to such extent that the introduction of the pre-heated hydrogen containing reducing agent generates the direct reduction of the metal oxide material and decreases cooling rate of the reduced metal material descending through the direct reduction facility for maintaining said required heat treatment temperature.

4. The method according to claim 1, wherein the method comprises pre-heating the hydrogen containing reducing agent to be introduced into the direct reduction facility by a reducing agent pre-heating device of the heat treatment providing device for reaching the required heat treatment temperature.

5. The method according to claim 1, wherein the step of upholding the required heat treatment temperature comprises:
adjusting the second thermal energy by a reducing agent thermal energy adjusting device electrically coupled to a first control circuitry configured to operate the reducing agent thermal energy adjusting device for controlling the required heat treatment temperature.

6. The method according to claim 1, wherein the step of upholding the required heat treatment temperature comprises:
adjusting mass flow of the hydrogen containing reducing agent introduced into the direct reduction facility by a reducing agent mass flow adjusting device electrically coupled to a second control circuitry configured to operate the reducing agent mass flow adjusting device for controlling the required heat treatment temperature.

7. The method according to any claim 1, wherein the step of upholding the required heat treatment temperature comprises:
adjusting a residence time period for keeping the reduced metal material in the direct reduction facility during a specific residence time period by a residence time period adjusting device electrically coupled to a third control circuitry configured to operate the residence time period adjusting device for achieving a specific residence time period and controlling the required heat treatment temperature.

8. The method according to claim 1, wherein the step of providing the required heat treatment temperature comprises:
adjusting pressurization of an interior of the direct reduction facility by a pressurization adjusting device electrically coupled to a fourth control circuitry configured to operate the pressurization adjusting device for controlling the required heat treatment temperature.

9. A metal material production configuration adapted for direct reduction of a metal oxide material holding a first thermal energy into a reduced metal material, the metal material production configuration comprising:
a metal oxide material provider unit configured to provide the metal oxide material holding the first thermal energy;
a direct reduction facility comprising:
a metal oxide material charging inlet device;
a reducing agent inlet device configured to introduce a hydrogen containing reducing agent holding a second thermal energy,
wherein the metal material production configuration comprises:
a direct reduction zone of the direct reduction facility configured to reduce the metal oxide material by using the first thermal energy of the metal oxide material to heat or further heat the introduced hydrogen containing reducing agent for providing a chemical reaction between the introduced hydrogen containing reducing agent and the metal oxide material;
a heat treatment zone of the direct reduction facility configured for heat treatment of the reduced metal material by exposing the reduced metal material to a required heat treatment temperature for providing heat treatment of the reduced metal material to obtain a densified reduced metal material;
a heat treatment providing device configured for upholding the required heat treatment temperature by introduction of a pre-heated hydrogen containing reducing agent; and
a metal material discharge device configured to discharge the reduced metal material that has been subjected to heat treatment.

10. The metal material production configuration according to claim 9, wherein the metal material production configuration further comprises a reducing agent pre-heating device of the heat treatment providing device adapted to pre-heat the hydrogen containing reducing agent to be introduced into the direct reduction facility.

11. The metal material production configuration according to claim 9, wherein:
the heat treatment providing device comprises a reducing agent thermal energy adjusting device configured to adjust the second thermal energy; and
a first control circuitry electrically coupled to the reducing agent thermal energy adjusting device and configured to control the reducing agent thermal energy adjusting device for reaching the required heat treatment temperature.

12. The metal material production configuration according to claim 9, wherein:
the heat treatment providing device comprises a reducing agent mass flow adjusting device configured to adjust the mass flow of the hydrogen containing reducing agent introduced into the direct reduction facility; and
a second control circuitry electrically coupled to the reducing agent mass flow adjusting device and configured to operate the reducing agent mass flow adjusting device to adjust the mass flow of the hydrogen containing reducing agent for reaching the required heat treatment temperature.

13. The metal material production configuration according claim 9, wherein:
the heat treatment providing device comprises a residence time period adjusting device configured to adjust a residence time period for keeping the reduced metal material in the direct reduction facility; and
a third control circuitry electrically coupled to the residence time period adjusting device and configured to operate the residence time period adjusting device for achieving said specific residence time period and controlling the required heat treatment temperature.

14. The metal material production configuration according claim 9, wherein:
the heat treatment providing device comprises a pressurization adjusting device configured to adjust pressurization of an interior of the direct reduction facility; and
a fourth control circuitry electrically coupled to the pressurization adjusting device and configured to operate the pressurization adjusting device for controlling the required heat treatment temperature.

15. The metal material production configuration according claim 9, wherein the direct reduction facility comprises a top gas outlet device configured to remove a top gas from the direct reduction facility.

16. The metal material production configuration according to claim 9, wherein the introduced pre-heated hydrogen containing reducing agent comprises 80-100% hydrogen, preferably 100% hydrogen by volume.

17. A data program comprising a program code readable on a computer of a control circuitry of the metal material production configuration according to claim 9, which data program is programmed for causing the heat treatment providing device to uphold the required heat treatment temperature by the introduction of the pre-heated hydrogen containing reducing agent.

18. A product produced by the method according to claim 1, wherein the reduced metal material consists of reduced iron ore particles bond to each other forming sponge iron of heat treated reduced iron ore material.

19. The method according to claim 1, wherein the method further comprises steps of:
decomposing water into electrolytic hydrogen and oxygen by an electrolysis unit;
producing methanol by reacting the electrolytic hydrogen with carbon dioxide;
storing the methanol;
reforming the methanol by using water and/or oxygen to provide carbon dioxide and released hydrogen;
providing the released hydrogen as a component of the pre-heated hydrogen containing reducing agent into the direct reduction facility; and
providing the step of introducing the pre-heated hydrogen containing reducing agent, holding the second thermal energy, into the direct reduction facility via the reducing agent inlet device.

20. The method according to claim 1, wherein the step of:
charging the metal oxide material holding the first thermal energy into the direct reduction facility via the metal oxide material charging inlet device is provided in conjunction with introduction of a first seal gas; and/or the step of:
discharging the reduced metal material provided in conjunction with introduction of a second seal gas.
